(19) United States
(12) Patent Application Publication
(10) Pub. No.: US 2017/0131818 A1
(43) Pub. Date: May 11, 2017

(54) TOUCH AND PRESSURE SENSING DEVICE

(71) Applicant: Industrial Technology Research Institute, Hsinchu (TW)

(72) Inventors: Chih-Chia Chang, Hsinchu County (TW); Kai-Ming Chang, New Taipei City (TW)

(21) Appl. No.: 15/173,734

(22) Filed: Jun. 6, 2016

Related U.S. Application Data
(60) Provisional application No. 62/253,146, filed on Nov. 10, 2015.

(30) Foreign Application Priority Data
Feb. 25, 2016 (TW) 105105611

(51) Int. Cl. G06F 3/041; G06F 3/044

(52) U.S. Cl. CPC G06F 3/0414; G06F 3/044

(57) ABSTRACT

A touch and pressure sensing device including a first sensing electrode layer, an insulating layer, a plurality of reflective structures, a second sensing electrode layer and a planarization layer. The insulating layer covers the first sensing electrode layer. The insulating layer is disposed between the first sensing electrode layer and the reflective structures. Each of the reflective structures has a first surface on the side away from the first sensing electrode layer, and each of the reflective structures has at least one side surface connected to the first surface. The second sensing electrode layer is formed on the first surface and the side surface. The second sensing electrode layer is partially overlapped with the first sensing electrode layer. The planarization layer covers the second sensing electrode layer.

### CROSS-REFERENCE TO RELATED APPLICATION

This application claims the priority benefits of U.S. provisional application Ser. No. 62/253,146, filed on Nov. 10, 2015 and Taiwan application serial no. 105105611, filed on Feb. 25, 2016. The entirety of each of the above-mentioned patent applications is hereby incorporated by reference herein and made a part of this specification.

### TECHNICAL FIELD

The technical field relates to a touch and pressure sensing device.

### BACKGROUND

In recent years, along with quick development of various applications such as information technology, wireless mobile communication, information appliances, etc., in order to achieve effects of more convenient, more compact size and more user-friendly, input devices of many information products have been changed from conventional keyboards and mice into touch panels. Moreover, more and more information products are integrated with a pressure sensing technique to achieve more diversified applications. Generally, techniques of touch input include a capacitive touch technique, a resistive touch technique, an optical touch technique, etc. Taking the capacitive touch technique as an example, an electrode used for providing a driving voltage and an electrode used for sensing electrical property are generally separately disposed. Based on a capacitance variation between the electrode used for providing the driving voltage and the electrode used for sensing electrical property, the technique of touch input is implemented. Moreover, the pressure sensing technique is generally implemented by sensing an electric signal variation generated when a sensing electrode of a pressure sensor is touch and pressed.

Presently, if a touch display panel is also used to implement a pressure sensing function in a same product, a fabrication process of setting a pressure sensor is added besides the fabrication process of the touch display panel. Therefore, the components of the product are relatively complicated, and the material cost and fabrication cost thereof are relatively high.

### SUMMARY

An embodiment of the disclosure provides a touch and pressure sensing device including a first sensing electrode layer, an insulating layer, a plurality of reflective structures, a second sensing electrode layer and a planarization layer. The insulating layer covers the first sensing electrode layer. The insulating layer is disposed between the first sensing electrode layer and the reflective structures. Each of the reflective structures has a first surface on the side away from the first sensing electrode layer, and each of the reflective structures has at least one side surface connected to the first surface. The second sensing electrode layer is formed on the first surface and the side surface. The second sensing electrode layer is partially overlapped with the first sensing electrode layer. The planarization layer covers the second sensing electrode layer.

An embodiment of the disclosure provides a touch and pressure sensing device including a first sensing electrode layer, an insulating layer and a second sensing electrode layer. The first sensing electrode layer includes a first electrode, a second electrode and a third electrode. One of the first electrode and the second electrode is a driving electrode configured to sense positions on a plane substantially parallel to the first sensing electrode layer. The other one of the first electrode and the second electrode is a sensing electrode configured to sense positions on the plane substantially parallel to the first sensing electrode layer. The insulating layer covers the first sensing electrode layer. The insulating layer is disposed between the first sensing electrode layer and the second sensing electrode layer, and the second sensing electrode layer is overlapped with the third electrode. The third electrode and the second sensing electrode layer are configured to sense a press position variation along a depth direction substantially perpendicular to the first sensing electrode layer.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a top view of a touch and pressure sensing device according to an embodiment of the disclosure.

FIG. 1B is an enlarged view of a region A of the touch and pressure sensing device of the embodiment of FIG. 1A.

FIG. 1C is a cross-sectional view of the touch and pressure sensing device of the embodiment of FIG. 1B configured on a display device and viewing along a line segment A-A′.

FIG. 1D is a cross-sectional view of the touch and pressure sensing device of the embodiment of FIG. 1B viewing along a line segment B-B′.

FIG. 1E is a three-dimensional view of reflective structures of the embodiment of FIG. 1A.

FIG. 1F is a cross-sectional view of another implementation of the touch and pressure sensing device of the embodiment of FIG. 1B viewing along the line segment B-B′.

FIG. 2A is a top view of a touch and pressure sensing device according to another embodiment of the disclosure.

FIG. 2B is an enlarged view of a region B of the touch and pressure sensing device of the embodiment of FIG. 2A.

FIG. 2C is a cross-sectional view of the touch and pressure sensing device of the embodiment of FIG. 2B viewing along a line segment C-C′.

FIG. 2D is a cross-sectional view of the touch and pressure sensing device of the embodiment of FIG. 2B viewing along a line segment D-D′.

FIG. 2E is a cross-sectional view of another implementation of the touch and pressure sensing device of the embodiment of FIG. 2B viewing along a line segment D-D′.

FIG. 3A is a top view of a touch and pressure sensing device according to still another embodiment of the disclosure.

FIG. 3B is an enlarged view of a region C of the touch and pressure sensing device of the embodiment of FIG. 3A.

FIG. 3C is a cross-sectional view of the touch and pressure sensing device of the embodiment of FIG. 3B viewing along a line segment E-E′.

FIG. 3D is a cross-sectional view of the touch and pressure sensing device of the embodiment of FIG. 3B viewing along a line segment F-F′.

FIG. 3E is a cross-sectional view of the touch and pressure sensing device of the embodiment of FIG. 3B viewing along a line segment G-G′.

FIG. 3F is a cross-sectional view of another implementation of the touch and pressure sensing device of the embodiment of FIG. 3B viewing along a line segment F-F′.

FIG. 4A is a top view of a touch and pressure sensing device according to still another embodiment of the disclosure.

FIG. 4B is a cross-sectional view of the touch and pressure sensing device of the embodiment of FIG. 4A viewing along a line segment H-H′.

FIG. 5 is a cross-sectional view of a part of a touch and pressure sensing device according to another embodiment of the disclosure.

FIG. 6 is a cross-sectional view of a part of a touch and pressure sensing device according to still another embodiment of the disclosure.

FIG. 7 is a cross-sectional view of a part of a touch and pressure sensing device according to still another embodiment of the disclosure.

FIG. 8 is a cross-sectional view of a part of a touch and pressure sensing device according to still another embodiment of the disclosure.

FIG. 9A is a cross-sectional view of a part of a touch and pressure sensing device according to still another embodiment of the disclosure.

FIG. 9B is a cross-sectional view of a part of a touch and pressure sensing device according to yet another embodiment of the disclosure.

FIG. 9C is a cross-sectional view of a part of a touch and pressure sensing device according to still another embodiment of the disclosure.

FIG. 9D is a cross-sectional view of a part of a touch and pressure sensing device according to yet another embodiment of the disclosure.

### DESCRIPTION OF EMBODIMENTS

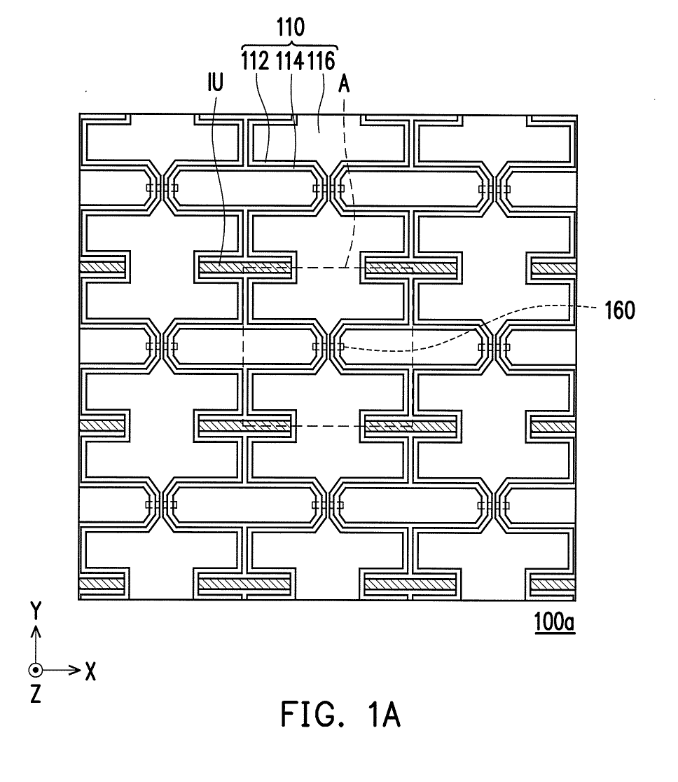

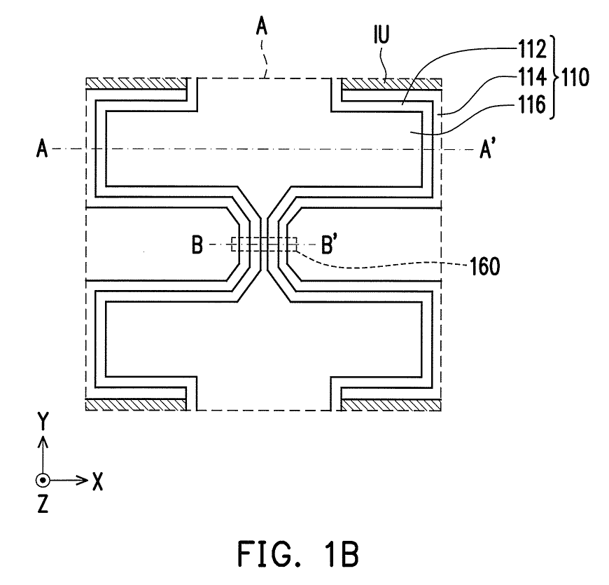

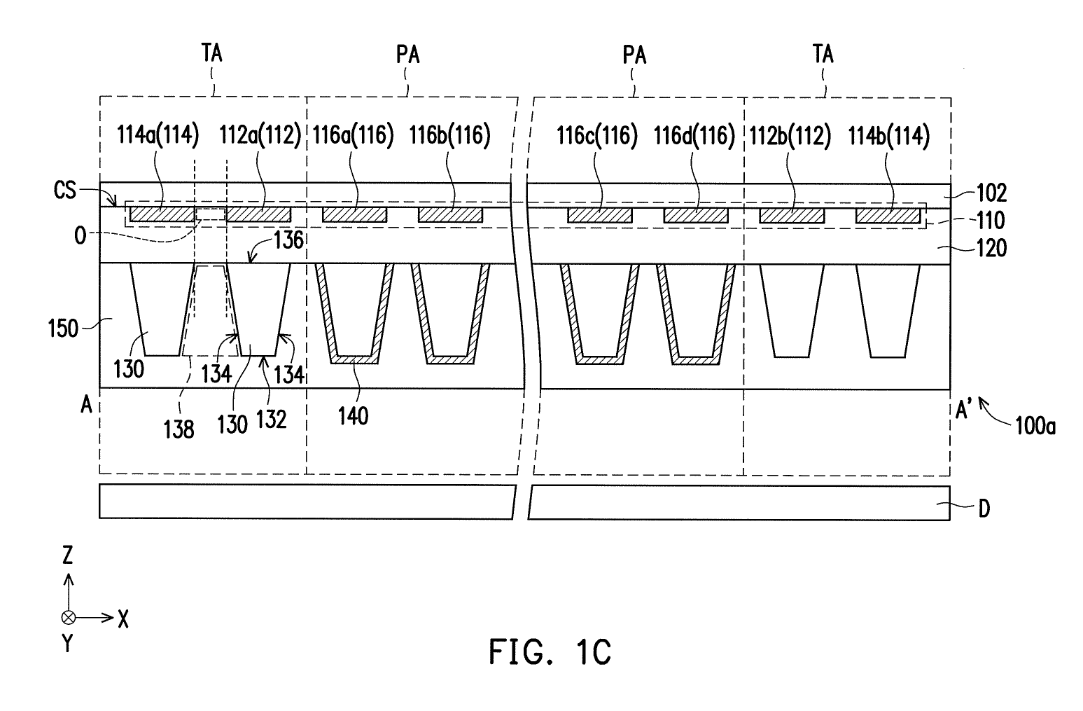

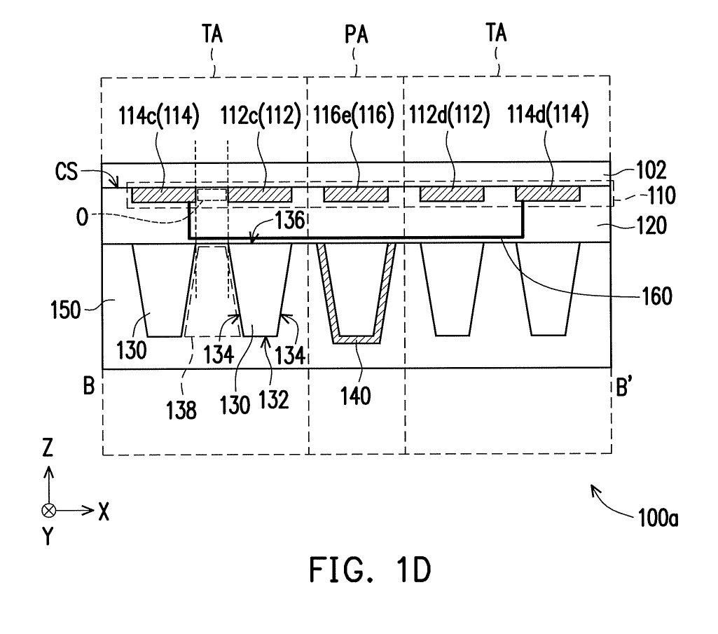

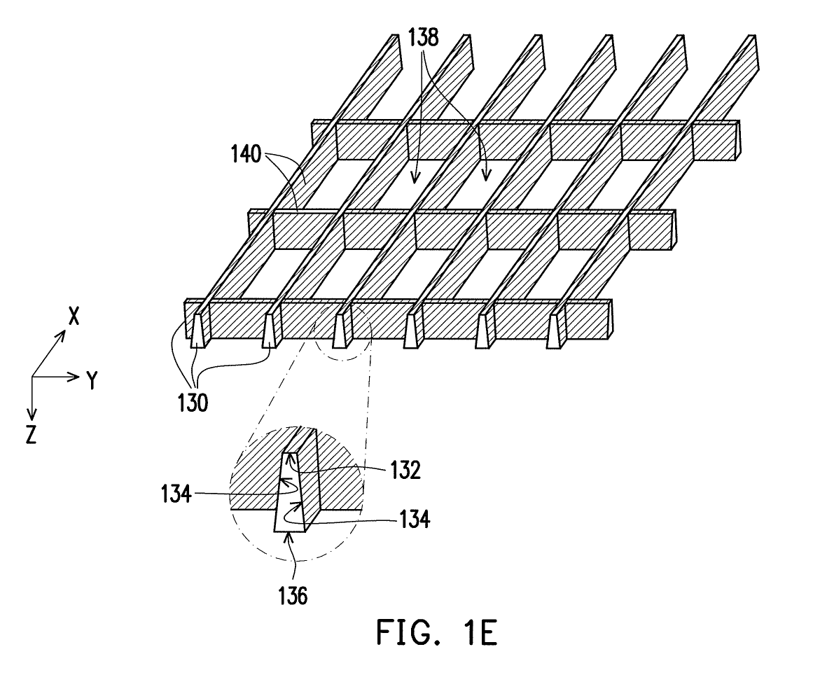

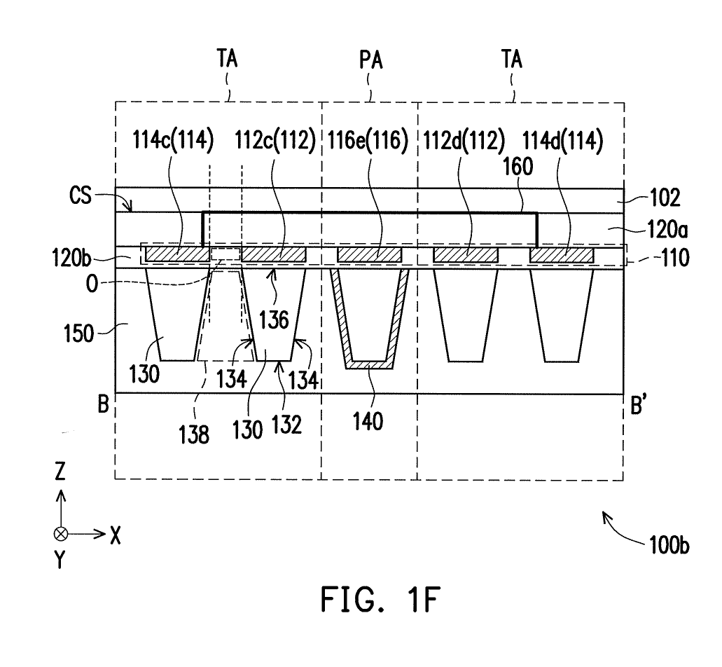

FIG. 1A is a top view of a touch and pressure sensing device according to an embodiment of the disclosure. Referring to FIG. 1A, in order to clearly present various components in the touch and pressure sensing device, the touch and pressure sensing device 100a shown FIG. 1A is a part of the complete touch and pressure sensing device. In the present embodiment, related description of the touch and pressure sensing device 100a may represent related description of the complete touch and pressure sensing device.

FIG. 1B is an enlarged view of a region A of the touch and pressure sensing device of the embodiment of FIG. 1A. Referring to FIG. 1A and FIG. 1B, in order to clearly present various components in the touch and pressure sensing device, openings O shown in FIG. 1C are omitted in FIG. 1A and FIG. 1B. In the present embodiment, the touch and pressure sensing device 100a includes a first sensing electrode layer 110. The first sensing electrode layer 110 includes a first electrode 112, a second electrode 114 and a third electrode 116. The touch and pressure sensing device 100a is, for example, located in a space constructed by a first axis X, a second axis Y and a third axis Z, where the first electrode 112, the second electrode 114 and the third electrode 116 are substantially arranged on a same plane constructed by the first axis X and the second axis Y to form a pattern. The first axis X extends along a horizontal direction. The second axis Y is perpendicular to the first axis X and extends along a vertical direction. Moreover, the third axis Z is perpendicular to the first axis X and perpendicular to the second axis Y.

FIG. 1C is a cross-sectional view of the touch and pressure sensing device of the embodiment of FIG. 1B configured on a display device and viewing along a line segment A-A′. In the present embodiment, the line segment A-A′ and a line segment B-B′ are cutting lines used for assisting description of internal components of the touch and pressure sensing device 100a in different regions. The line segment A-A′ and a line segment B-B′ of the present embodiment are not used for limiting the disclosure. Moreover, a line segment C-C′, a line segment D-D′, a line segment E-E′, a line segment F-F′, a line segment G-G′, a line segment H-H′ and a line segment I-I′ in following embodiments are also used for assisting description of internal components of the touch and pressure sensing device of different embodiments in different regions. The line segment C-C′, the line segment D-D′, the line segment E-E′, the line segment F-F′, the line segment G-G′, the line segment H-H′ and the line segment I-I′ are not used for limiting the disclosure.

Referring to FIG. 1C, the touch and pressure sensing device 100a further includes a substrate 102, an insulating layer 120, a plurality of reflective structures 130, a second sensing electrode layer 140 and a planarization layer 150. The substrate 102 has a carrying surface CS. The first sensing electrode layer 110 is disposed on the carrying surface CS. The insulating layer 120 covers the first sensing electrode layer 110, and the insulating layer 120 is disposed between the first sensing electrode layer 110 and the reflective structures 130. To be specific, each of the reflective structures 130 has a first surface 132 on the side away from the first sensing electrode layer 110, and each of the reflective structures 130 has at least one side surface 134 (a plurality of side surfaces 134 in the present embodiment) connected to the first surface 132. Moreover, each of the reflective structures 130 has a second surface 136 on the side close to the first sensing electrode layer 110, and the side surfaces 134 connect the first surface 132 and the second surface 136.

In the present embodiment, the second sensing electrode layer 140 is formed on the first surface 132 and the side surfaces 134 of the reflective structures 130, and the planarization layer 150 covers the second sensing electrode layer 140. To be specific, the touch and pressure sensing device 100a is adapted to be configured on a display device D. The display device D is adapted to be configured on a surface of the planarization layer 150 located at a side away from the carrying surface CS. A display image beam of the display device D enters the touch and pressure sensing device 100a through the surface of the planarization layer 150 located at the side away from the carrying surface CS, and emits out through another surface of the substrate 102 opposite to the carrying surface CS. In the present embodiment, the display device D can be a liquid crystal display (LCD), a plasma display, an organic light-emitting diode (OLED) display, an electrowetting display (EWD), and electro-phoretic display (EPD), an electrochromic display (ECD) or other applicable display devices. Moreover, the display device D is, for example, adhered on the surface of the planarization layer 150 located at the side away from the carrying surface CS through an adhesive material, which is not limited by the disclosure.

In the present embodiment, a material of the substrate 102 is a transparent material. To be specific, the material of the substrate 102 is, for example, polyimide (PI), polycarbonate (PC), polyethersulfone (PES), polyacrylate (PA), polynorbornene (PNB), polyethylene terephthalate (PET), polyetheretherketone (PEEK), polyethylene naphthalate (PEN), polyetherimide (PEI), glass or other transparent materials, which is not limited by the disclosure.

FIG. 1E is a three-dimensional view of the reflective structures of the embodiment of FIG. 1A. Please refer to FIG. 1C and FIG. 1E for related description of the reflective structures 130. In the present embodiment, each of the reflective structures 130 is a reflective wall, and the reflective walls are arranged in a grid layout. To be specific, the first surface 132, the second surface 136 and the side surfaces 134 of the reflective structure 130 are planes, and the reflective walls are connected to each other to form a rectangle grid arrangement structure. However, in some embodiments, the surfaces of the reflective structures can also be non-planar, for example, curved surfaces, and the reflective structures can be arranged in other shapes, which is not limited by the disclosure.

In the present embodiment, a light guide space 138 is formed between two adjacent reflective structures 130. The first sensing electrode layer 110 has a plurality of openings O, and the openings O expose the light guide spaces 138. Moreover, besides that the planarization layer 150 covers the second sensing electrode layer 140, the planarization layer 150 is also filled in the light guide spaces 138. In the present embodiment, materials of the reflective structures 130 and the planarization layer 150 are, for example, transparent materials. The reflective structures 130 and the planarization layer 150 can be made of polymer, resin, light sensitive resin, positive photoresist, negative photoresist, etc., which is not limited by the disclosure. Moreover, a refractive index of the planarization layer 150 is greater than a refractive index of the reflective structures 130. To be specific, the refractive index of the planarization layer 150 ranges from 1.3 to 2.0, and the refractive index of the reflective structures 130 ranges from 1.0 to 1.7. In the present embodiment, an area of the second surface 136 of the reflective structures 130 is greater than an area of the first surface 132 thereof. Referring to FIG. 1C, the display image beam of the display device D enters the light guide spaces 138 between the reflective structures 130 along the direction of the third axis Z, and is propagated in the planarization layer 150 filled in the light guide spaces 138. To be specific, the display image beam is reflected (for example, has a total reflection) between the planarization layer 150 and the reflective structures 130, and is propagated in the light guide spaces 138, and emits out through end surfaces of the light guide spaces 138 facing the carrying surface CS. Then, the display image beam emits out through the openings O. Moreover, the display image beam can also be reflected by the second sensing electrode layer 140 located on the side surfaces 134 of the reflective structures 130 for propagating in the light guide spaces 138, and emits out through the openings O. In the present embodiment, shapes of the light guide spaces 138 are, for example, polygonal columns or round columns. In some embodiments, the shapes of the light guide spaces 138 are, for example, irregular columns, and the shapes of the light guide spaces 138 are not limited by the disclosure.

In the present embodiment, areas of end surfaces of the light guide spaces 138 located away from the carrying surface CS, i.e. the end surfaces facing the display device D, are respectively smaller than an area of a display pixel (not shown) of the display device D configured corresponding to the touch and pressure sensing device 100a. Therefore, when the display device D and the touch and pressure sensing device 100a are assembled, a process of accurate alignment can be omitted. However, in some embodiments, the areas of the end surfaces of the light guide spaces 138 located away from the carrying surface CS can also be respectively equal to the area of each display pixel, so as to achieve higher light usage efficiency, which is not limited by the disclosure. Moreover, in the present embodiment, an area of the second surface 136 of each of the reflective structures 130 is greater than an area of the first surface 132 thereof. However, in some embodiment, the area of the second surface 136 can be equal to the area of the first surface 132, or the area of the second surface 136 can be smaller than the area of the first surface 132, which is not limited by the disclosure.

Then, referring to FIG. 1B and FIG. 1C, the first electrode 112 includes a plurality of first electrode regions. The first electrode 112 at least includes a first electrode region 112a and a first electrode region 112b. The second electrode 114 includes a plurality of second electrode regions. The second electrode 114 at least includes a second electrode region 114a and a second electrode region 114b. The third electrode 116 includes a plurality of third electrode regions. The third electrode 116 at least includes a third electrode region 116a, a third electrode region 116b, a third electrode region 116c and a third electrode region 116d. To be specific, the first electrode regions and the second electrode regions are electrically isolated, and each of the first electrode regions is disposed adjacent to one second electrode region to form at least a part of a touch sensing area. For example, the first electrode region 112a and the second electrode region 114a are disposed adjacent to each other to form at least a part of a touch sensing area TA, and the first electrode region 112b and the second electrode region 114b are disposed adjacent to each other to form at least a part of another touch sensing area TA. Moreover, in the present embodiment, the third electrode region 116a, the third electrode region 116b, the third electrode region 116c and the third electrode region 116d disposed adjacent to each other form at least a part of a pressure sensing area PA.

In the present embodiment, the reflective structures 130 corresponding to the first electrode region 112a, the first electrode region 112b, the second electrode region 114a and the second electrode region 114b in the touch sensing area TA along the direction of the third axis Z are not configured with the second sensing electrode layer 140 thereon. Comparatively, the reflective structures 130 corresponding to the third electrode region 116a, the third electrode region 116b, the third electrode region 116e and the third electrode region 116d in the pressure sensing area PA along the direction of the third axis Z are configured with the second sensing electrode layer 140 thereon. However, in some embodiments, the reflective structures 130 corresponding to the first electrode regions and the second electrode regions in the touch sensing area TA along the direction of the third axis Z can also be configured with the second sensing electrode layer 140 thereon, which is not limited by the disclosure.

To be specific, one of the first electrode 112 and the second electrode 114 is a driving electrode configured to sense positions on a plane substantially parallel to the first sensing electrode layer 110. The other one of the first electrode 112 and the second electrode 114 is a sensing electrode configured to sense positions on the plane substantially parallel to the first sensing electrode layer 110, where the plane substantially parallel to the first sensing electrode layer 110 is, for example, a plane constructed by the first axis X and the second axis Y. To be specific, the first electrode region 112a is a driving electrode configured to sense positions on the plane substantially parallel to the first sensing electrode layer 110 in a capacitive touch control, and the second electrode region 114a disposed adjacent to the first electrode region 112a is a sensing electrode configured to sense positions on the plane substantially parallel to the first sensing electrode layer 110 in the capacitive touch control. The first electrode region 112a and the second electrode region 114a form at least a part of the touch sensing area TA, which is configured to sense positions on the plane substantially parallel to the first sensing electrode layer 110 according to a variation of electric signals of the first electrode region 112a and the second electrode region 114a, for example, a difference of capacitance values or a variation of resistance values. Similarly, the first electrode region 112b serves as the driving electrode similar to the first electrode region 112a, and the second electrode region 114b disposed adjacent to the first electrode region 112b serves as the sensing electrode similar to the second electrode region 114a. The first electrode region 112b and the second electrode region 114b form at least a part of another touch sensing area TA, which is configured to sense positions on the plane substantially parallel to the first sensing electrode layer 110.

In the present embodiment, the second sensing electrode layer 140 of the touch and pressure sensing device 100a is partially overlapped with the first sensing electrode layer 110. The second sensing electrode layer 140 is partially overlapped with the third electrode 116. To be specific, the second sensing electrode layer 140 and the third electrode 116 are configured to sense a press position variation along a depth direction substantially perpendicular to the first sensing electrode layer 110, where the depth direction is, for example, an extending direction of the third axis Z. For example, the second sensing electrode layer 140 corresponding to the third electrode region 116a along the direction of the third axis Z and the third electrode region 116a are configured to sense a press position variation along a depth direction substantially perpendicular to the first sensing electrode layer 110 according to a variation of electric signals of the second sensing electrode layer 140 and the third electrode region 116a, for example, a difference of capacitance values or a variation of resistance values. Similarly, the third electrode region 116h, the third electrode region 116c and the third electrode region 116d and the corresponding second sensing electrode layer 140 are respectively configured to sense a press position variation along a depth direction substantially perpendicular to the first sensing electrode layer 110. The third electrode region 116a, the third electrode region 116b, the third electrode region 116c and the third electrode region 116d form at least a part of a pressure sensing area PA, which is configured to sense a press position variation along a depth direction substantially perpendicular to the first sensing electrode layer 110. In the present embodiment, an overlapped area between the first sensing electrode layer 110 and the second sensing electrode layer 140 exceeds 70% of the area of the first sensing electrode layer 110. However, in some embodiments, the overlapping area between the first sensing electrode layer 110 and the second sensing electrode layer 140 and the area of the first sensing electrode layer 110 may have other proportional relationships, which are not limited by the disclosure.

FIG. 1D is a cross-sectional view of the touch and pressure sensing device of the embodiment of FIG. 1B viewing along a line segment B-B′. Referring to FIG. 1B and FIG. 1D, in the present embodiment, on a cross section of the touch and pressure sensing device 100a along the line segment B-B′, the first electrode 112 further includes a first electrode region 112c and a first electrode region 112d, and the second electrode 114 further includes a second electrode region 114c and a second electrode region 114d, and the third electrode 116 further includes a third electrode region 116e. The first electrode region 112c and the second electrode region 114c form at least a part of a touch sensing area TA, and the first electrode region 112d and the second electrode region 114d form at least a part of another touch sensing area TA. Moreover, the third electrode region 116e forms at least a part of a pressure sensing area PA. In the present embodiment, the third electrode region 116e is disposed between two adjacent touch sensing areas TA. To be specific, at least a part of the pressure sensing area PA formed by the third electrode region 116e is disposed between two adjacent touch sensing areas TA.

In the present embodiment, the touch and pressure sensing device 100a further includes a connection layer 160. The insulating layer 120 is disposed between the first sensing electrode layer 110 and the connection layer 160, and the first electrode regions or the second electrode regions are connected and electrically conducted through the connection layer 160. To be specific, the connection layer 160 is disposed between the first sensing electrode layer 110 and the reflective structures 130. The second electrode region 114c and the second electrode region 114d are connected and electrically conducted through the connection layer 160. In some other embodiments, according to an electrode pattern design of the first sensing electrode layer 110, the first electrode region 112c and the first electrode region 112d can be designed to be connected and electrically conducted through the connection layer 160, which is not limited by the disclosure.

Referring to FIG. 1A, and FIG. 1C and FIG. 1D, in the present embodiment, the first electrode 112, the second electrode 114 and the third electrode 116 of the first sensing electrode layer 110 are arranged on a plane constructed by the first axis X and the second axis Y to form a pattern. To be specific, in view of the whole touch and pressure sensing device 100a, the first electrode 112 may implement electrical transmission along an extending direction of the second axis Y. Moreover, due to the separation by the second electrode 114 and the third electrode 116, in view of the whole touch and pressure sensing device 100a, the first electrode 112 cannot implement electrical transmission along an extending direction of the first axis X. In the present embodiment, the touch and pressure sensing device 100a further includes an insulating unit IU. Due to the insulation of the insulating unit IU, in view of the whole touch and pressure sensing device 100a, the second electrode 114 cannot implement electrical transmission along the extending direction of the second axis Y. Moreover, since the second electrode regions of the second electrode 114 are connected and electrically conducted through the connection layer 160, the second electrode 114 may implement electrical transmission along the extending direction of the first axis X in view of the whole touch and pressure sensing device 100a. Besides, the third electrode 116 may implement electrical transmission along the extending direction of the second axis Y in view of the whole touch and pressure sensing device 100a. However, due to the separation by the first electrode 112 and the second electrode 114, the third electrode 116 cannot implement electrical transmission along the extending direction of the first axis X in view of the whole touch and pressure sensing device 100a.

In the touch and pressure sensing device 100a of the present embodiment, the first electrode 112 of the first sensing electrode layer 110 may implement electrical transmission along the extending direction of the second axis Y, and serve as a driving electrode used for sensing positions on a plane substantially parallel to the first sensing electrode layer 110. The second electrode 114 may implement electrical transmission along the extending direction of the first axis X, and serve as a sensing electrode used for sensing positions on the plane substantially parallel to the first sensing electrode layer 110. Therefore, the touch and pressure sensing device 100a has a touch sensing function. The third electrode 116 of the first sensing electrode layer 110 may implement electrical transmission along the extending direction of the second axis Y. The third electrode 116 and the second sensing electrode layer 140 are used for sensing a press position variation along a depth direction substantially perpendicular to the first sensing electrode layer 110. Therefore, the touch and pressure sensing device 100a has a pressure sensing function. Besides, the touch and pressure sensing device 100a includes a plurality of reflective structures 130, and a light guide space 138 is formed between two adjacent reflective structures 130, and the planarization layer 150 is filled in the light guide spaces 138. Moreover, the first sensing electrode layer 110 has a plurality of openings O, and the openings O expose the light guide spaces 138. The display image beam of the display device D can be propagated in the light guide spaces 138, and emits out through the openings O, such that the touch and pressure sensing device 100a has an optical transmission function. In the present embodiment, the touch and pressure sensing device 100a integrates the touch sensing function, the pressure sensing function and the optical transmission function in a single device. Therefore, during the fabrication process of the touch and pressure sensing device 100a, it is unnecessary to additionally add a fabrication process of a pressure sensor besides the fabrication process of a touch display panel. The components of the touch and pressure sensing device 100a are simple, and material cost and fabrication cost thereof are relatively low. Besides, in some embodiments, a Young's modulus value of the material of the reflective structures 130 of the touch and pressure sensing device 100a is greater than a Young's modulus value of the material of the planarization layer 150 by at least 10 MPa. In the embodiments, the reflective structures 130 may provide a support force, and the planarization layer 150 may absorb an external impact force. Therefore, when the touch and pressure sensing device of the aforementioned embodiments is configured on a display device (for example, the display panel D), the external impact force suffered by the display device is decreased, and the display device is not liable to be damaged due to the external impact force.

FIG. 1F is a cross-sectional view of another implementation (i.e. another embodiment) of the touch and pressure sensing device of the embodiment of FIG. 1B viewing along the line segment B-B′. Referring to FIG. 1F, in the present embodiment, the touch and pressure sensing device 100b is similar to the touch and pressure sensing device 100a of the embodiment of FIG. 1D. Description of the components of the touch and pressure sensing device 100b may refer to related description of the touch and pressure sensing device 100a of the embodiment of FIG. 1D, and detail thereof is not repeated. A difference between the touch and pressure sensing device 100b and the touch and pressure sensing device 100a is that the touch and pressure sensing device 100b includes an insulating layer 120a and an insulating layer 120b. The connection layer 160 of the touch and pressure sensing device 100b is disposed between the substrate 102 and the insulating layer 120a, and the first sensing electrode layer 110 is disposed between the insulating layer 120a and the insulating layer 120b. In the present embodiment, the second electrode region 114c and the second electrode region 114d are connected and electrically conducted through the connection layer 160. To be specific, a fabrication method of the touch and pressure sensing device 100b includes following steps. First, the connection layer 160 is fabricated on the carrying surface CS of the substrate 102. Then, the insulating layer 120a is fabricated to cover the connection layer 160. Thereafter, the first sensing electrode layer 110 is fabricated on the insulating layer 120a, and the insulating layer 120b is fabricated to cover the first sensing electrode layer 110. In the present embodiment, similar to the touch and pressure sensing device 100a of FIG. 1D, the touch and pressure sensing device 100b integrates the touch sensing function, the pressure sensing function and the optical transmission function in a single device, and material cost and fabrication cost thereof are relatively low.

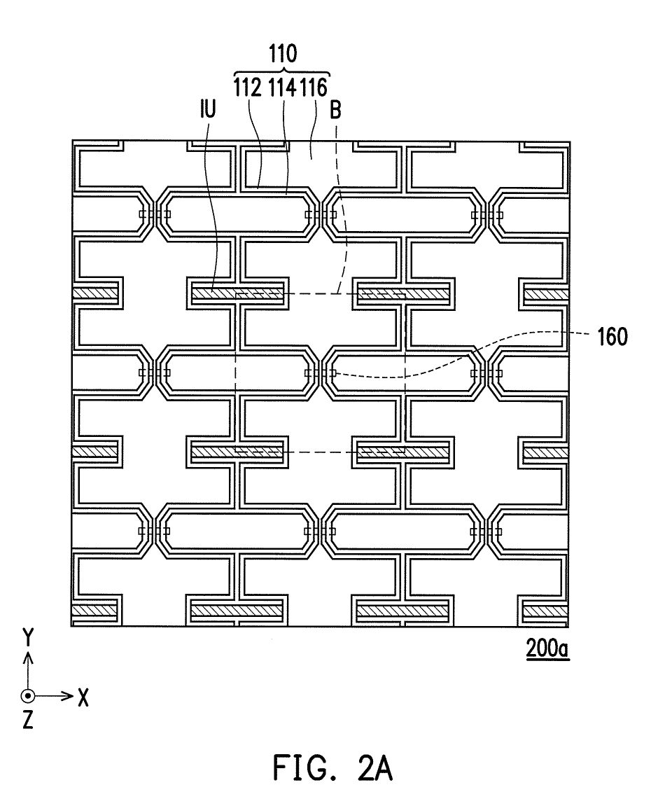

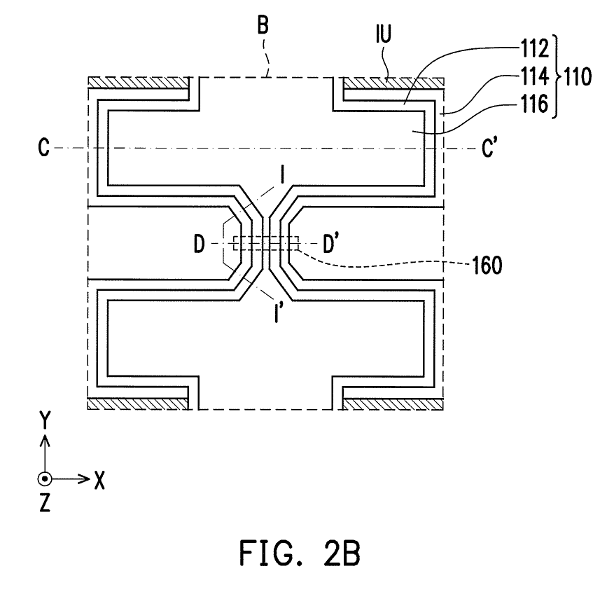

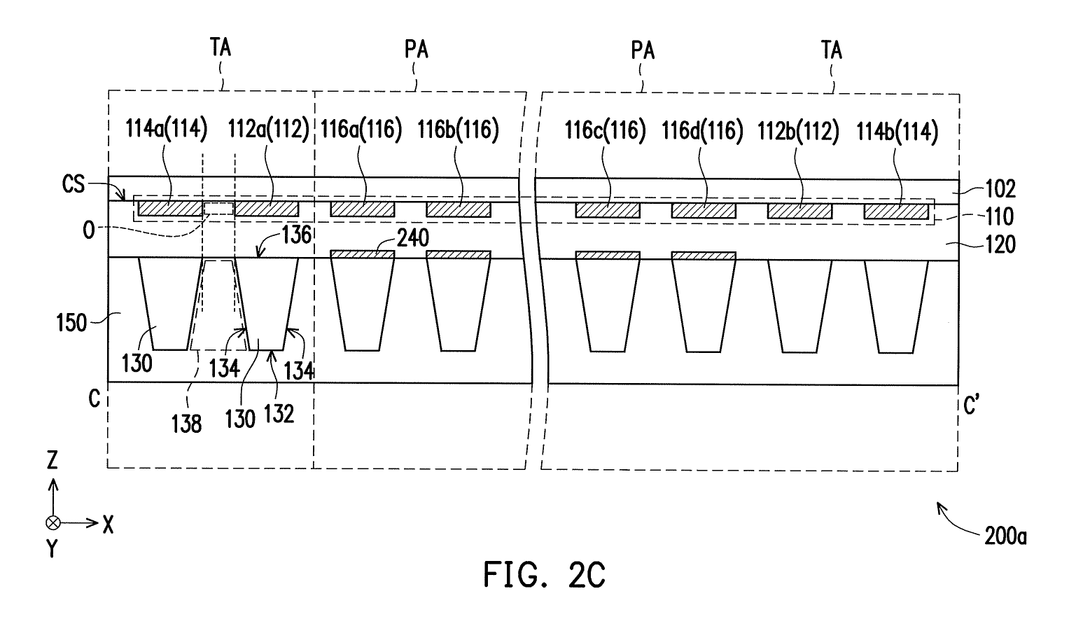

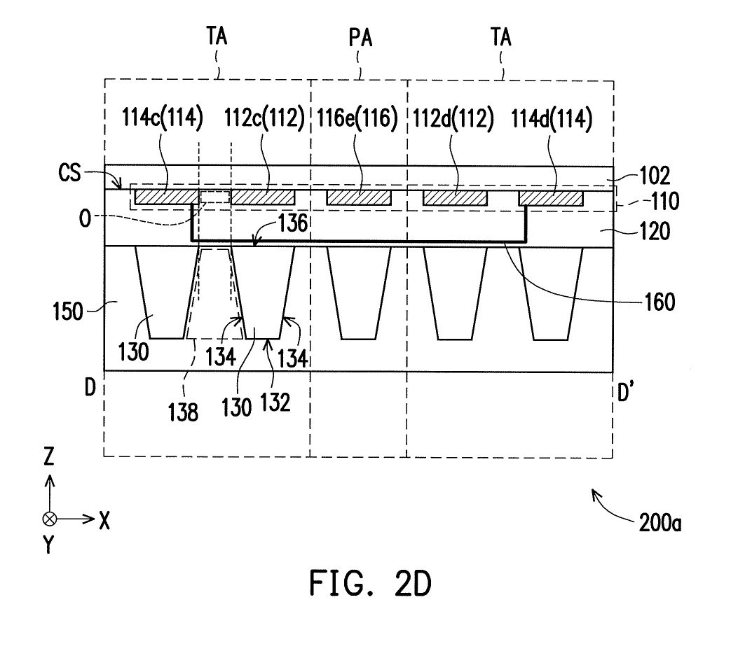

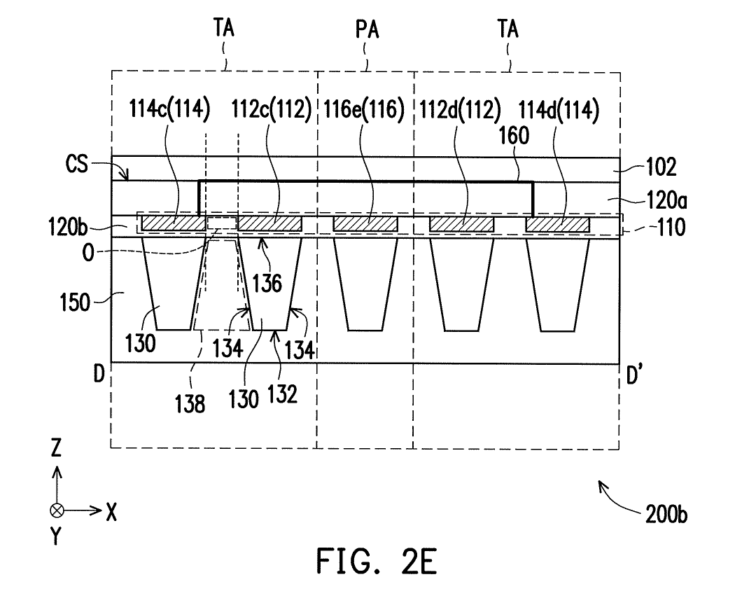

FIG. 2A is a top view of a touch and pressure sensing device according to another embodiment of the disclosure, FIG. 2B is an enlarged view of a region B of the touch and pressure sensing device of the embodiment of FIG. 2A, and FIG. 2C is a cross-sectional view of the touch and pressure sensing device of the embodiment of FIG. 2B viewing along a line segment C-C′. Referring to FIG. 2A, FIG. 2B and FIG. 2C, in order to clearly present various components in the touch and pressure sensing device, the openings O shown in FIG. 2C are omitted in FIG. 2A and FIG. 2B. In the present embodiment, the touch and pressure sensing device 200a is similar to the touch and pressure sensing device 100a of the embodiment of FIG. 1A. Description of the components of the touch and pressure sensing device 200a may refer to related description of the touch and pressure sensing device 100a of the embodiment of FIG. 1A, and detail thereof is not repeated. A difference between the touch and pressure sensing device 200a and the touch and pressure sensing device 100a is that the insulating layer 120 of the touch and pressure sensing device 200a is disposed between the first sensing electrode layer 110 and the second sensing electrode layer 240. The second sensing electrode layer 240 is partially overlapped with the third electrode 116. To be specific, the second sensing electrode layer 240 is formed on the second surface 136 of the reflective structures 130. In some embodiments, the second sensing electrode layer 240 can also be partially formed on the first surface 132 and the side surfaces 134 of the reflective structures 130. Moreover, in other embodiments, the touch and pressure sensing device 200a may include none of the reflective structures 130, and the second sensing electrode layer 240 is formed between the first sensing electrode layer 110 and the planarization layer 150. The second sensing electrode layer 240 has a plurality of openings corresponding to the openings O on the first sensing electrode layer 110, and the openings on the second sensing electrode layer 240 and the openings O on the first sensing electrode layer 110 expose the planarization layer 150, though the disclosure is not limited thereto.

In the present embodiment, a sum of an area of the first electrode 112 and an area of the second electrode 114 of the touch and pressure sensing device 200a exceeds 20% of an area of the first sensing electrode layer 110. However, in some embodiments, the first electrode 112 and the second electrode 114 with proper areas can also be set according to an actual demand of touch design, which is not limited by the disclosure.

FIG. 2D is a cross-sectional view of the touch and pressure sensing device of the embodiment of FIG. 2B viewing along a line segment D-D′. Referring to FIG. 2B and FIG. 2D, in the present embodiment, in view of the cross section of the touch and pressure sensing device 200a along the line segment D-D′, the first electrode 112 further includes a first electrode region 112c and a first electrode region 112d, the second electrode 114 further includes a second electrode region 114c and a second electrode region 114d, and the third electrode 116 further includes a third electrode region 116e. In the present embodiment, the second electrode region 114c and the second electrode region 114d are connected and electrically conducted through the connection layer 160 of the touch and pressure sensing device 200a. Moreover, in the present embodiment, the second sensing electrode layer 240 may bypass a position where the connection layer 160 is located to keep its connection. For example, the second sensing electrode layer 240 may bypass the position where the connection layer 160 is located along a line segment I-I′ shown in FIG. 2B to keep its connection.

Referring to FIG. 2A, in the present embodiment, the first electrode 112 of the first sensing electrode layer 110 may implement electrical transmission along the extending direction of the second axis Y, and serve as a driving electrode used for sensing positions on a plane substantially parallel to the first sensing electrode layer 110. The second electrode 114 may implement electrical transmission along the extending direction of the first axis X, and serve as a sensing electrode used for sensing positions on the plane substantially parallel to the first sensing electrode layer 110. Moreover, the third electrode 116 of the first sensing electrode layer 110 may implement electrical transmission along the extending direction of the second axis Y. The third electrode 116 and the second sensing electrode layer 240 are used for sensing a press position variation along a depth direction substantially perpendicular to the first sensing electrode layer 110. Moreover, the display image beam of the display device (not shown) can be propagated in the light guide spaces 138, and emits out through the openings O of the first sensing electrode layer 110. Therefore, similar to the touch and pressure sensing device 100a of the embodiment of FIG. 1A, the touch and pressure sensing device 200a integrates the touch sensing function, the pressure sensing function and the optical transmission function in a single device, and the components of the touch and pressure sensing device 200a are simple, and the material cost and fabrication cost thereof are relatively low.

FIG. 2E is a cross-sectional view of another implementation (i.e. another embodiment) of the touch and pressure sensing device of the embodiment of FIG. 2B viewing along a line segment D-D′. Referring to FIG. 2E, in the present embodiment, the touch and pressure sensing device 200b is similar to the touch and pressure sensing device 200a of the embodiment of FIG. 2D. Description of the components of the touch and pressure sensing device 200b may refer to related description of the touch and pressure sensing device 200a of the embodiment of FIG. 2D, and detail thereof is not repeated. A difference between the touch and pressure sensing device 200b and the touch and pressure sensing device 200a is that the touch and pressure sensing device 200b includes an insulating layer 120a and an insulating layer 120b. The connection layer 160 of the touch and pressure sensing device 200b is disposed between the substrate 102 and the insulating layer 120a, and the first sensing electrode layer 110 is disposed between the insulating layer 120a and the insulating layer 120b. In the present embodiment, the second electrode region 114c and the second electrode region 114d are connected and electrically conducted through the connection layer 160. To be specific, a fabrication method of the touch and pressure sensing device 200b includes following steps. First, the connection layer 160 is fabricated on the carrying surface CS of the substrate 102. Then, the insulating layer 120a is fabricated to cover the connection layer 160. Thereafter, the first sensing electrode layer 110 is fabricated on the insulating layer 120a, and the insulating layer 120b is fabricated to cover the first sensing electrode layer 110. In the present embodiment, similar to the touch and pressure sensing device 200a of FIG. 2D, the touch and pressure sensing device 200b integrates the touch sensing function, the pressure sensing function and the optical transmission function in a single device, and material cost and fabrication cost thereof are relatively low.

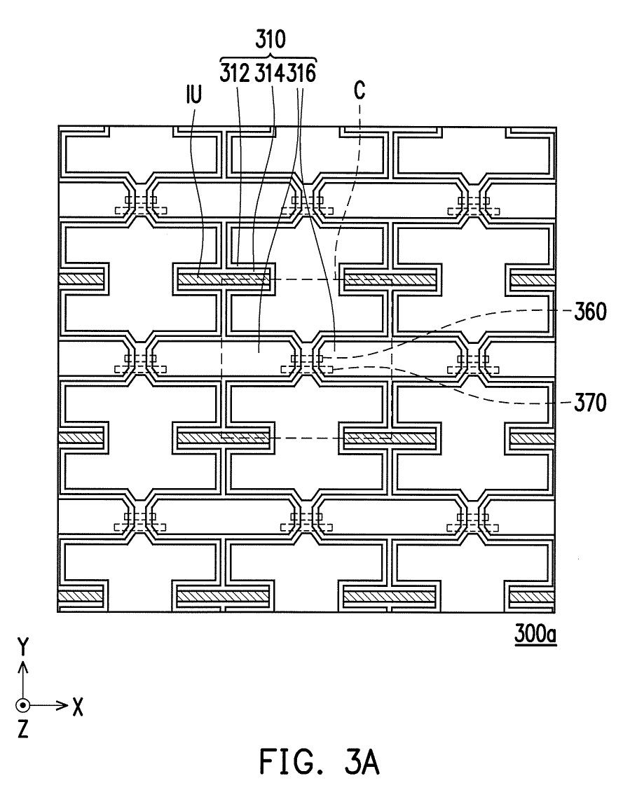

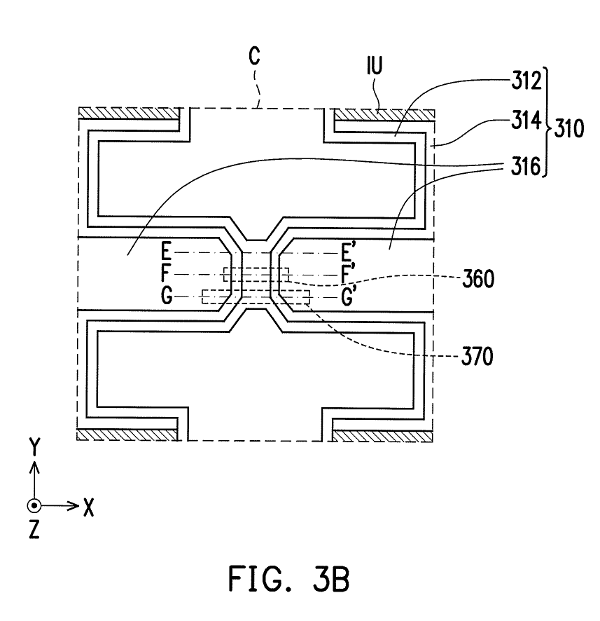

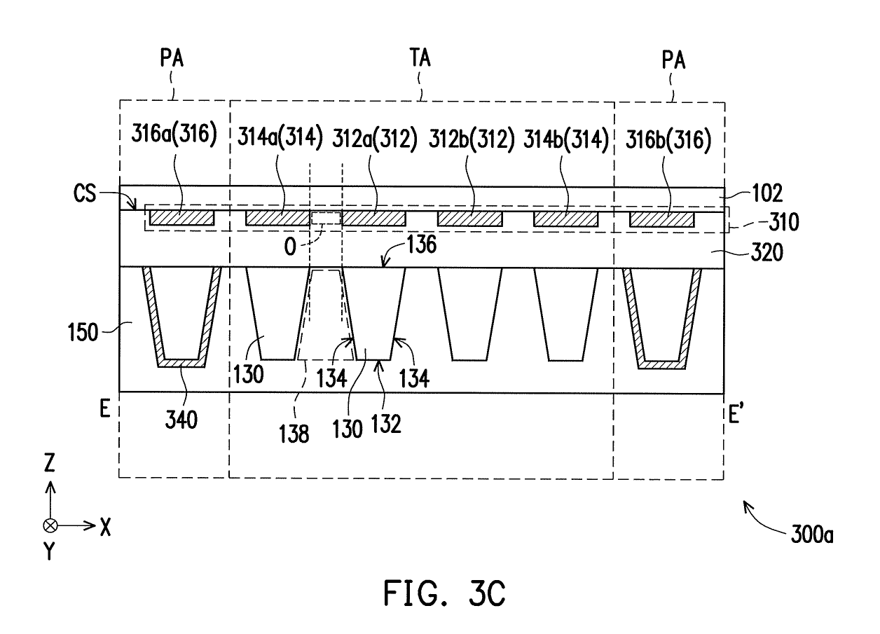

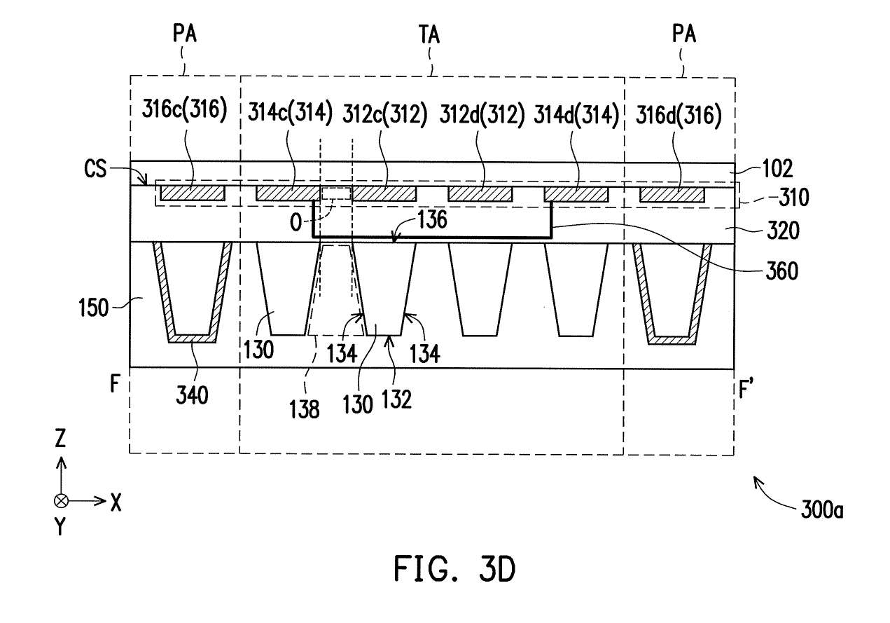

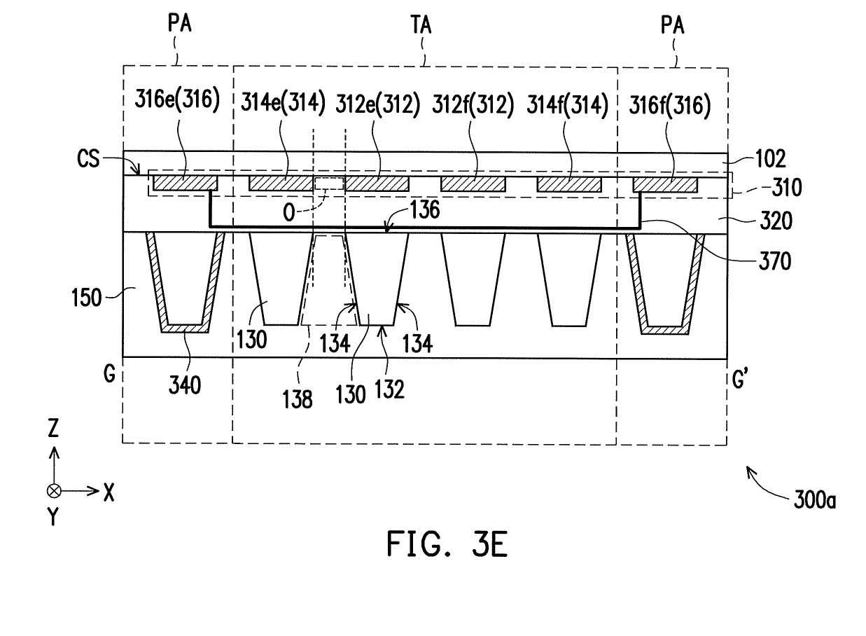

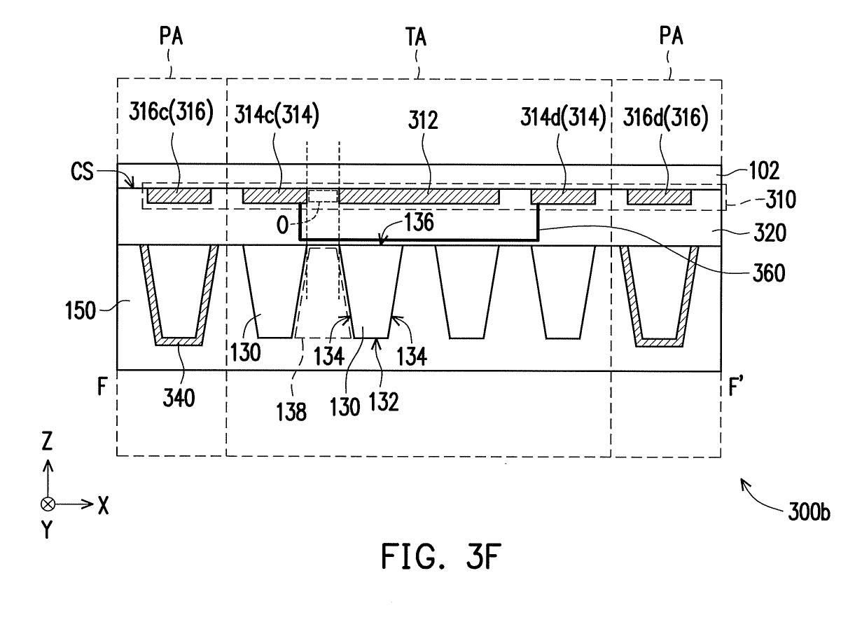

FIG. 3A is a top view of a touch and pressure sensing device according to still another embodiment of the disclosure, FIG. 3B is an enlarged view of a region C of the touch and pressure sensing device of the embodiment of FIG. 3A, and FIG. 3C is a cross-sectional view of the touch and pressure sensing device of the embodiment of FIG. 3B viewing along a line segment E-E′. Referring to FIG. 3A, FIG. 3B and FIG. 3C, in order to clearly present various components in the touch and pressure sensing device, the openings O shown in FIG. 3C are omitted in FIG. 3A and FIG. 3B. In the present embodiment, the touch and pressure sensing device 300a is similar to the touch and pressure sensing device 100a of the embodiment of FIG. 1A. Description of the components of the touch and pressure sensing device 300a may refer to related description of the touch and pressure sensing device 100a of the embodiment of FIG. 1A, and detail thereof is not repeated. A difference between the touch and pressure sensing device 300a and the touch and pressure sensing device 100a is that the touch and pressure sensing device 300a includes a first sensing electrode layer 310. The first sensing electrode layer 310 is disposed between the insulating layer 320 and the substrate 102. The first sensing electrode layer 310 includes a first electrode 312, a second electrode 314 and a third electrode 316. In the present embodiment, the first electrode 312 at least includes a first electrode region 312a and a first electrode region 312b, the second electrode 314 at least includes a second electrode region 314a and a second electrode region 314b, and the third electrode 316 at least includes a third electrode region 316a and a third electrode region 316b. To be specific, the first electrode region 312a and the second electrode region 314a form at least a part of a touch sensing area TA, and the first electrode region 312b and the second electrode region 314b form at least a part of the touch sensing area TA. Moreover, the third electrode region 316a and the third electrode region 316b form at least a part of a pressure sensing area PA.

In the present embodiment, the reflective structures 130 corresponding to the first electrode region 312a, the first electrode region 312b, the second electrode region 314a and the second electrode region 314b in the touch sensing area TA along the direction of the third axis Z are not configured with the second sensing electrode layer 340 thereon. Comparatively, the reflective structures 130 corresponding to the third electrode region 316a and the third electrode region 316b in the pressure sensing area PA along the direction of the third axis Z are configured with the second sensing electrode layer 340 thereon.

FIG. 3D is a cross-sectional view of the touch and pressure sensing device of the embodiment of FIG. 3B viewing along a line segment F-F′. Referring to FIG. 3B and FIG. 3D, in the present embodiment, in view of the cross section of the touch and pressure sensing device 300a along the line segment F-F′, the first electrode 312 further includes a first electrode region 312c and a first electrode region 312d, the second electrode 314 further includes a second electrode region 314c and a second electrode region 314d, and the third electrode 316 further includes a third electrode region 316c and a third electrode region 316d. The first electrode region 312c and the second electrode region 314c form at least a part of a touch sensing area TA, and the first electrode region 312d and the second electrode region 314d form at least a part of another touch sensing area TA. Moreover, the third electrode region 316c and the third electrode region 316d form at least a part of a pressure sensing area PA. In the present embodiment, the touch and pressure sensing device 300a further includes a connection layer 360. The connection layer 360 is disposed between the first sensing electrode layer 310 and the reflective structures 130. The second electrode region 314c and the second electrode region 314d are connected and electrically conducted through the connection layer 360.

FIG. 3E is a cross-sectional view of the touch and pressure sensing device of the embodiment of FIG. 3B viewing along a line segment G-G′. Referring to FIG. 3B and FIG. 3E, in the present embodiment, in view of the cross section of the touch and pressure sensing device 300a along the line segment G-G′, the first electrode 312 further includes a first electrode region 312e and a first electrode region 312f, the second electrode 314 further includes a second electrode region 314e and a second electrode region 314f, and the third electrode 316 further includes a third electrode region 316e and a third electrode region 316f. The first electrode region 312e and the second electrode region 314e form at least a part of a touch sensing area TA, and the first electrode region 312f and the second electrode region 314f form at least a part of another touch sensing area TA. Moreover, the third electrode region 316e and the third electrode region 316f form at least a part of a pressure sensing area PA. In the present embodiment, the touch and pressure sensing device 300a further includes a connection layer 370. The connection layer 370 is disposed between the first sensing electrode layer 310 and the reflective structures 130. The third electrode region 316e and the third electrode region 316f are connected and electrically conducted through the connection layer 370.

Referring to 3A, and referring to FIG. 3C, FIG. 3D and FIG. 3E, in the present embodiment, in view of the whole touch and pressure sensing device 300a, the first electrode 312 may implement electrical transmission along the extending direction of the second axis Y, but cannot implement electrical transmission along the extending direction of the first axis X. In view of the whole touch and pressure sensing device 300a, the second electrode 314 may implement electrical transmission along the extending direction of the first axis X through the connection layer 360, but cannot implement electrical transmission along the extending direction of the second axis Y. Moreover, in view of the whole touch and pressure sensing device 300a, the third electrode 316 may implement electrical transmission along the extending direction of the first axis X through the connection layer 370, but cannot implement electrical transmission along the extending direction of the second axis Y.

In the touch and pressure sensing device 300a of the present embodiment, the first electrode 312 of the first sensing electrode layer 310 may implement electrical transmission along the extending direction of the second axis Y, and serve as a driving electrode used for sensing positions on a plane substantially parallel to the first sensing electrode layer 310. The second electrode 314 may implement electrical transmission along the extending direction of the first axis X, and serve as a sensing electrode used for sensing positions on the plane substantially parallel to the first sensing electrode layer 310. Moreover, the third electrode 316 may implement electrical transmission along the extending direction of the first axis X. In the present embodiment, the third electrode 316 and the second sensing electrode layer 340 are used for sensing a press position variation along a depth direction substantially perpendicular to the first sensing electrode layer 310. Moreover, the display image beam of the display device (not shown) can be propagated in the light guide spaces 138, and emits out through the openings O of the first sensing electrode layer 310. Therefore, similar to the touch and pressure sensing device 100a of the embodiment of FIG. 1A, the touch and pressure sensing device 300a integrates the touch sensing function, the pressure sensing function and the optical transmission function in a single device, and the components of the touch and pressure sensing device 200a are simple, and the material cost and fabrication cost thereof are relatively low.

FIG. 3F is a cross-sectional view of another implementation (i.e. another embodiment) of the touch and pressure sensing device of the embodiment of FIG. 3B viewing along a line segment F-F′. Referring to FIG. 3F, in the present embodiment, the touch and pressure sensing device 300b is similar to the touch and pressure sensing device 300a of the embodiment of FIG. 3D. Description of the components of the touch and pressure sensing device 300b may refer to related description of the touch and pressure sensing device 300a of the embodiment of FIG. 3D, and detail thereof is not repeated. A difference between the touch and pressure sensing device 300b and the touch and pressure sensing device 300a is that on the cross section of the touch and pressure sensing device 300b along the line segment F-F′, the first electrode 312 is not divided into a plurality of electrodes, and the first electrode 312 forms an electrode region. To be specific, the electrode region formed by the first electrode 312 and the second electrode region 314c form at least a part of a touch sensing area TA, and the electrode region formed by the first electrode 312 and the second electrode region 314d form at least a part of another touch sensing area TA. Moreover, the third electrode region 316c and the third electrode region 316d form at least a part of a pressure sensing region PA. In the present embodiment, similar to the touch and pressure sensing device 300a of the embodiment of FIG. 3D, the touch and pressure sensing device 300b integrates the touch sensing function, the pressure sensing function and the optical transmission function in a single device, and the material cost and fabrication cost thereof are relatively low.

To be specific, in other implementations (i.e. other embodiments) of the touch and pressure sensing device of the embodiment of FIG. 3A, whether the electrodes are further divided into a plurality of electrodes can be designed according to an actual requirement. For example, in a different implementation of the touch and pressure sensing device of the embodiment of FIG. 3A, the first electrode 312 is not divided into a plurality of electrodes, and the first electrode 312 forms an electrode region. Moreover, in some embodiments, the second electrode 314 is not divided into a plurality of electrodes, and the second electrode 314 forms an electrode region. Moreover, in other embodiments, the third electrode 316 is not divided into a plurality of electrodes, and the third electrode 316 forms an electrode region, which is not limited by the disclosure.

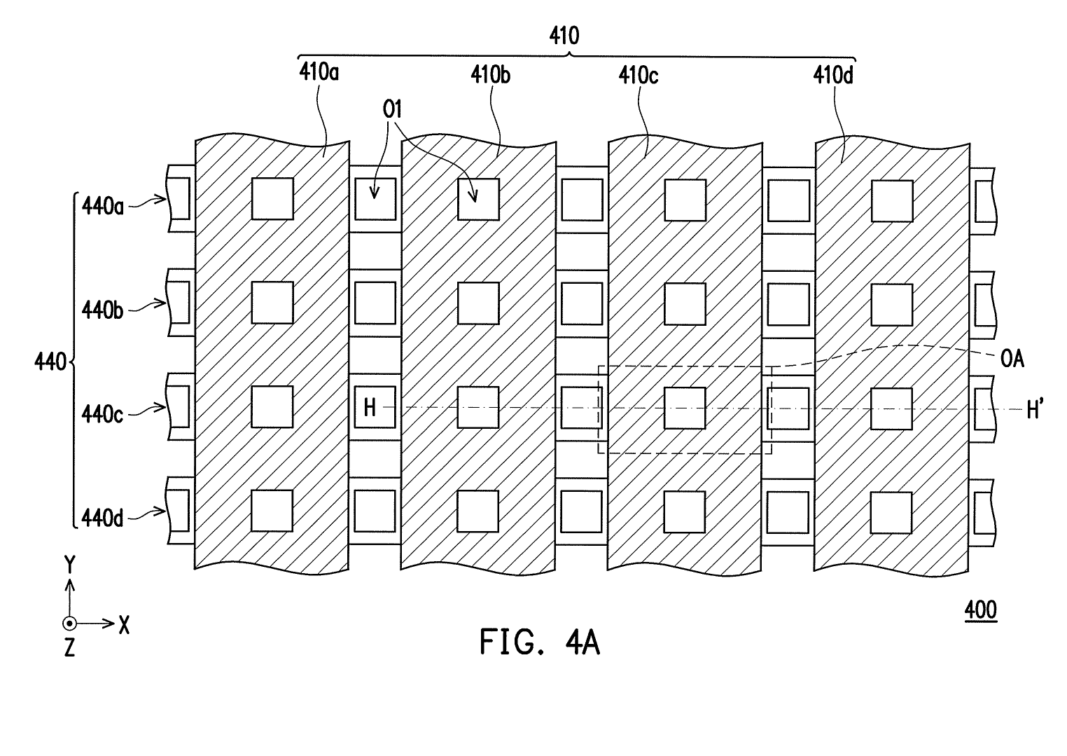

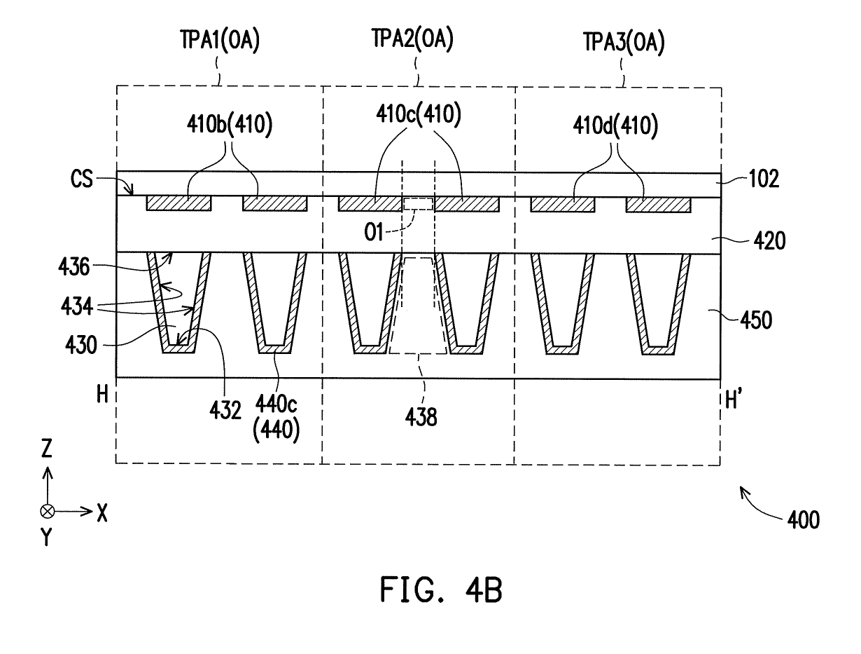

FIG. 4A is a top view of a touch and pressure sensing device according to still another embodiment of the disclosure, and FIG. 4B is a cross-sectional view of the touch and pressure sensing device of the embodiment of FIG. 4A viewing along a line segment H-H′. Referring to FIG. 4A and FIG. 4B, in the present embodiment, the touch and pressure sensing device 400 is similar to the touch and pressure sensing device 100a of the embodiment of FIG. 1A. Description of the components of the touch and pressure sensing device 400 may refer to related description of the touch and pressure sensing device 100a of the embodiment of FIG. 1A, and detail thereof is not repeated. A difference between the touch and pressure sensing device 400 and the touch and pressure sensing device 100a is that the touch and pressure sensing device 400 includes a first sensing electrode layer 410, an insulating layer 420, a plurality of reflective structures 430, a second sensing electrode layer 440 and a planarization layer 450. The first sensing electrode layer 410 includes a plurality of first sub-sensing electrode, and the second sensing electrode layer 440 includes a plurality of second sub-sensing electrodes. The first sub-sensing electrodes are separated from each other, and the second sub-sensing electrodes are separated from each other. To be specific, the first sensing electrode layer 410 at least includes a first sub-sensing electrode 410a, a first sub-sensing electrode 410b, a first sub-sensing electrode 410c and a first sub-sensing electrode 410d separated from each other, and the second sensing electrode layer 440 at least includes a second sub-sensing electrode 440a, a second sub-sensing electrode 440b, a second sub-sensing electrode 440c and a second sub-sensing electrode 440d separated from each other. In the present embodiment, the first sub-sensing electrodes and the second sub-sensing electrodes form a plurality of overlapped areas OA.

Referring to FIG. 4B, in the present embodiment, the overlapped areas OA include a touch and pressure sensing area TPA1, a touch and pressure sensing area TPA2 and a touch and pressure sensing area TPA3. The first sub-sensing electrode 410b forms at least a part of the touch and pressure sensing area TPA1, the first sub-sensing electrode 410c forms at least a part of the touch and pressure sensing area TPA2, and the first sub-sensing electrode 410d forms at least a part of the touch and pressure sensing area TPA3. Moreover, each of the reflective structures 430 has a first surface 432 at a side away from the first sensing electrode layer 410, and each of the reflective structures 430 has a plurality of side surfaces 434 connected to the first surface 432. Moreover, each of the reflective structures 430 has a second surface 436 at a side close to the first sensing electrode layer 410, and the side surfaces 434 are connected to the first surface 432 and the second surface 436. The second sub-sensing electrode 440a, the second sub-sensing electrode 440b, the second sub-sensing electrode 440c and the second sub-sensing electrode 440d of the second sensing electrode layer 440 are formed on the first surface 432 and the side surfaces 436 of the reflective structures 430.

In the touch and pressure sensing device 400 of the present embodiment, the first sub-sensing electrode 410b of the touch and pressure sensing area TPA1 and the second sensing electrode layer 440 corresponding to the first sub-sensing electrode 410b along the extending direction of the third axis Z (for example, the second sub-sensing electrode 440c) are used for sensing positions on a plane substantially parallel to the first sensing electrode layer 410 according to electric signal variations of the first sub-sensing electrode 410b and the second sub-sensing electrode 440c. Similarly, the first sub-sensing electrode 410c of the touch and pressure sensing area TPA2 and the second sub-sensing electrode 440c can also be used for sensing positions on the plane substantially parallel to the first sensing electrode layer 410. The first sub-sensing electrode 410d of the touch and pressure sensing area TPA3 and the second sub-sensing electrode 440c can also be used for sensing positions on the plane substantially parallel to the first sensing electrode layer 410. To be specific, the first sub-sensing electrode 410b, the first sub-sensing electrode 410c and the first sub-sensing electrode 410d may be used in collaboration with the second sub-sensing electrode 440c to sense a press position variation along a depth direction substantially perpendicular to the first sensing electrode layer 410.

In the touch and pressure sensing device 400 of the present embodiment, the first sub-sensing electrodes of the first sensing electrode layer 410 and the second sub-sensing electrodes of the second sensing electrode layer 440 may sense positions on the plane substantially parallel to the first sensing electrode layer 410, and sense a press position variation along the depth direction substantially perpendicular to the first sensing electrode layer 410. Moreover, the display image beam of the display device (not shown) can be propagated in the light guide space 138 located between two adjacent reflective structures 430, and emits out through a plurality of openings O1 of the first sensing electrode layer 410. Therefore, similar to the touch and pressure sensing device 100a of the embodiment of FIG. 1A, the touch and pressure sensing device 400 integrates the touch sensing function, the pressure sensing function and the optical transmission function in a single device, and the components of the touch and pressure sensing device 400 are simple, and the material cost and fabrication cost thereof are relatively low.

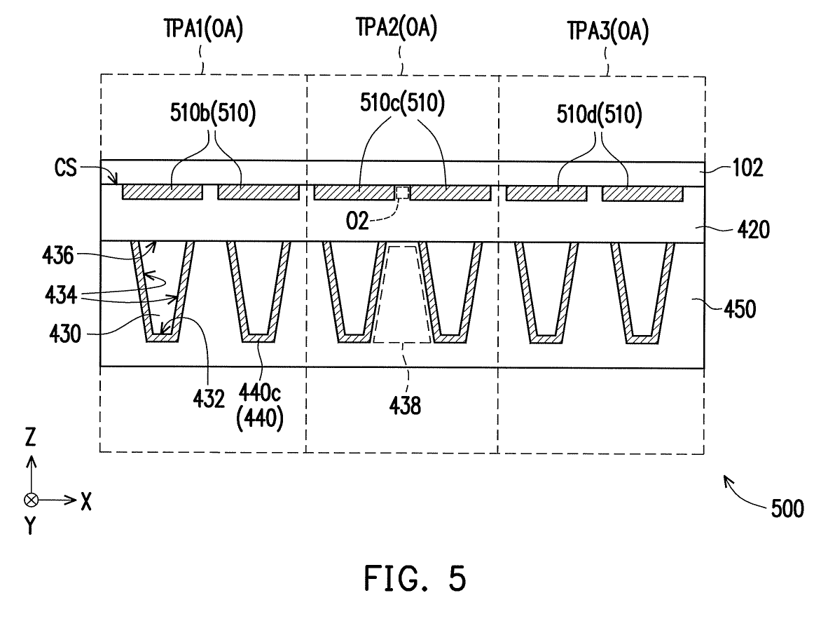

FIG. 5 is a cross-sectional view of a part of a touch and pressure sensing device according to another embodiment of the disclosure. Referring to FIG. 5, in the present embodiment, the touch and pressure sensing device 500 is similar to the touch and pressure sensing device 400 of the embodiment of FIG. 4A. Description of the components of the touch and pressure sensing device 500 may refer to related description of the touch and pressure sensing device 400 of the embodiment of FIG. 4A, and detail thereof is not repeated. A difference between the touch and pressure sensing device 500 and the touch and pressure sensing device 400 is that the first sensing electrode layer 510 of the touch and pressure sensing device 500 includes a first sub-sensing electrode 510b, a first sub-sensing electrode 510c and a first sub-sensing electrode 510d. The first sensing electrode layer 510 has a plurality of openings O2, and the openings O2 expose the light guide spaces 438. To be specific, an area of the first sensing electrode layer 510 of the present embodiment is greater than that of the first sensing electrode layer 410 of the embodiment of FIG. 4A and FIG. 4B, and the openings O2 of the present embodiment are smaller than the openings O1 of the embodiment of FIG. 4A and FIG. 4B. To be specific, since the area of the first sensing electrode layer 510 of the present embodiment is greater than that of the first sensing electrode layer 410 of the embodiment of FIG. 4A and FIG. 4B, a touch effect of the touch and pressure sensing device 500 is better than that of the touch and pressure sensing device 400. Comparatively, since the openings O1 of the embodiment of FIG. 4A and FIG. 4B are greater than the openings O2 of the present embodiment, an optical display brightness of the touch and pressure sensing device 400 is higher than an optical display brightness of the touch and pressure sensing device 500. In the present embodiment, similar to the touch and pressure sensing device 100a of the embodiment of FIG. 1A, the touch and pressure sensing device 500 integrates the touch sensing function, the pressure sensing function and the optical transmission function in a single device, and the components of the touch and pressure sensing device 500 are simple, and the material cost and fabrication cost thereof are relatively low.

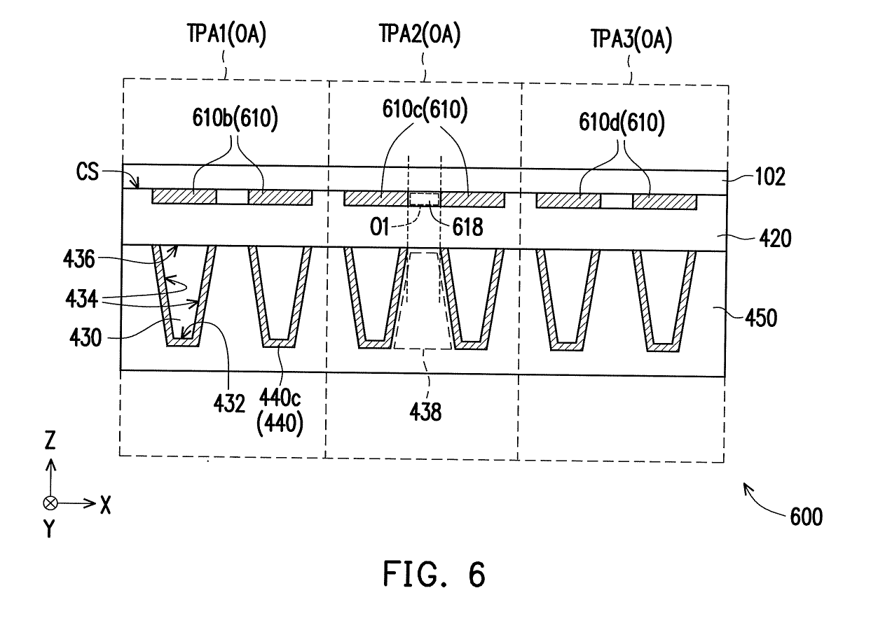

FIG. 6 is a cross-sectional view of a part of a touch and pressure sensing device according to still another embodiment of the disclosure. Referring to FIG. 6, in the present embodiment, the touch and pressure sensing device 600 is similar to the touch and pressure sensing device 400 of the embodiment of FIG. 4A. Description of the components of the touch and pressure sensing device 600 may refer to related description of the touch and pressure sensing device 400 of the embodiment of FIG. 4A, and detail thereof is not repeated. A difference between the touch and pressure sensing device 600 and the touch and pressure sensing device 400 is that the first sensing electrode layer 610 of the touch and pressure sensing device 600 includes a first sub-sensing electrode 610b, a first sub-sensing electrode 610c and a first sub-sensing electrode 610d. Moreover, the first sensing electrode layer 610 includes a plurality of transparent conductive electrodes 618, and each of the transparent conductive electrodes 618 is disposed on an opening O1. To be specific, the transparent conductive electrodes 618 can be made of a material having both of an electrical conductivity property and a light transmitting property such as indium tin oxide (ITO) or other transparent conductive materials. The transparent conductive electrodes 618 may make the openings to be pervious to light while maintaining conductivity of the first sensing electrode layer 610. Therefore, the display image beam of the display device (not shown) can be propagated in the light guide spaces 438, and emits out through the openings O of the first sensing electrode layer 610. In the present embodiment, similar to the touch and pressure sensing device 100a of the embodiment of FIG. 1A, the touch and pressure sensing device 600 integrates the touch sensing function, the pressure sensing function and the optical transmission function in a single device, and the components of the touch and pressure sensing device 600 are simple, and the material cost and fabrication cost thereof are relatively low.

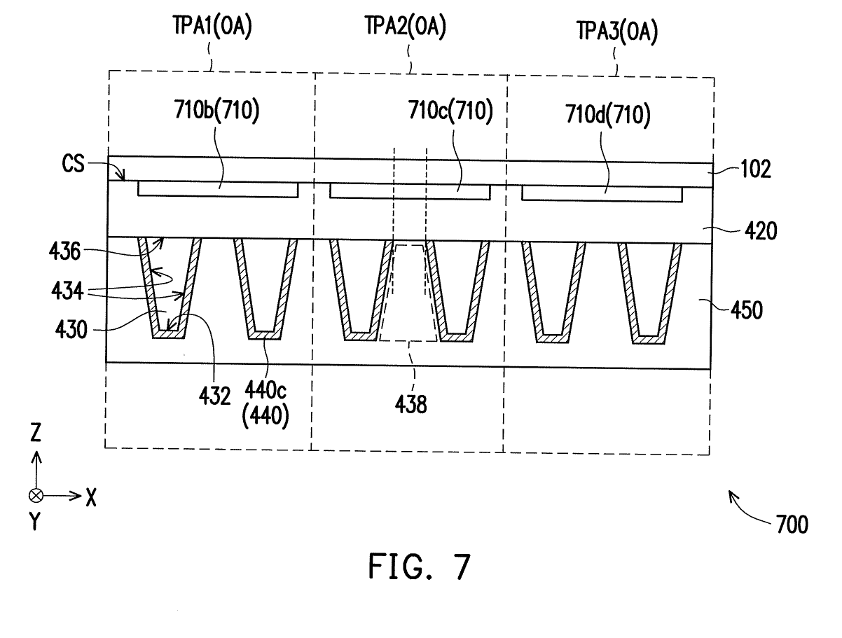

FIG. 7 is a cross-sectional view of a part of a touch and pressure sensing device according to still another embodiment of the disclosure. Referring to FIG. 7, in the present embodiment, the touch and pressure sensing device 700 is similar to the touch and pressure sensing device 400 of the embodiment of FIG. 4A. Description of the components of the touch and pressure sensing device 700 may refer to related description of the touch and pressure sensing device 400 of the embodiment of FIG. 4A, and detail thereof is not repeated. A difference between the touch and pressure sensing device 700 and the touch and pressure sensing device 400 is that the first sensing electrode layer 710 of the touch and pressure sensing device 700 includes a first sub-sensing electrode 710b, a first sub-sensing electrode 710c and a first sub-sensing electrode 710d. Moreover, the material of the first sensing electrode layer 710 is similar to the transparent conductive material of the transparent conductive electrodes 618 of the embodiment of FIG. 6. Moreover, the first sensing electrode layer 710 does not have an opening. To be specific, the display image beam of the display device (not shown) can be propagated in the light guide spaces 438, and emits out through the first sensing electrode layer 710. In the present embodiment, similar to the touch and pressure sensing device 100a of the embodiment of FIG. 1A, the touch and pressure sensing device 700 integrates the touch sensing function, the pressure sensing function and the optical transmission function in a single device, and the components of the touch and pressure sensing device 700 are simple, and the material cost and fabrication cost thereof are relatively low.

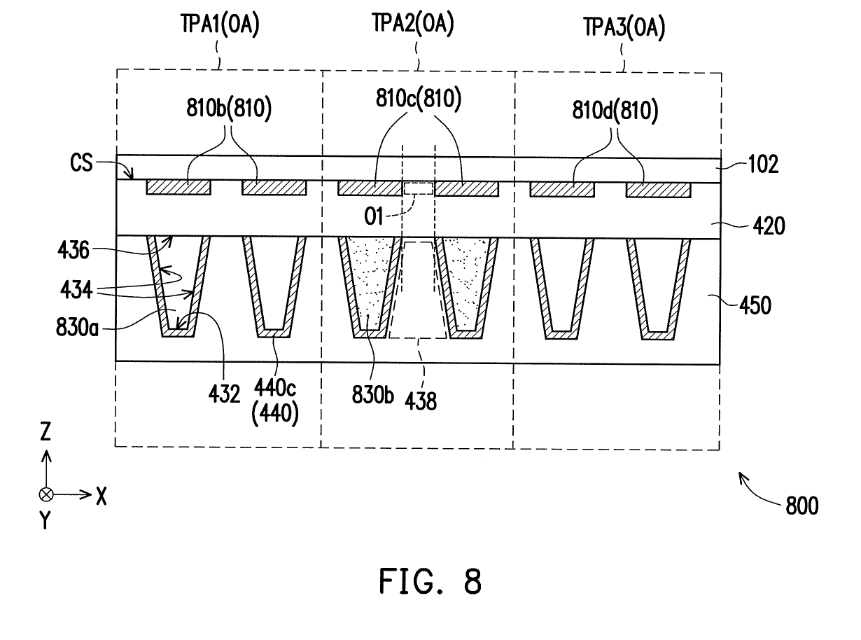

FIG. 8 is a cross-sectional view of a part of a touch and pressure sensing device according to still another embodiment of the disclosure. Referring to FIG. 8, in the present embodiment, the touch and pressure sensing device 800 is similar to the touch and pressure sensing device 400 of the embodiment of FIG. 4A. Description of the components of the touch and pressure sensing device 800 may refer to related description of the touch and pressure sensing device 400 of the embodiment of FIG. 4A, and detail thereof is not repeated. A difference between the touch and pressure sensing device 800 and the touch and pressure sensing device 400 is that the overlapped area OA of the touch and pressure sensing device 800 includes a touch and pressure sensing area TPA1, a touch and pressure sensing area TPA2 and a touch and pressure sensing area TPA3. In the present embodiment, the touch and pressure sensing area TPA1 and the touch and pressure sensing area TPA3 serve as a first touch and pressure sensing area of the touch and pressure sensing device 800, and the touch and pressure sensing area TPA2 serves as a second touch and pressure sensing area of the touch and pressure sensing device 800. To be specific, the first sensing electrode layer 810 includes a first sub-sensing electrode 810b, a first sub-sensing electrode 810c and a first sub-sensing electrode 810d. The first touch and pressure sensing area includes reflective structures 830a corresponding to the first sub-sensing electrode 810b and reflective structures 830a corresponding to the first sub-sensing electrode 810d. Moreover, the second touch and pressure sensing area includes reflective structures 830b corresponding to the first sub-sensing electrode 810c. In the present embodiment, a Young's modulus value of the material of the reflective structures 830a is different to a Young's modulus value of the material of the reflective structures 830b.

To be specific, the Young's modulus value of the material of the reflective structures 830b is greater than the Young's modulus value of the material of the reflective structures 830a. When a user touches the substrate 102 at a position where the reflective structures 830b are located, the reflective structures 830b are not easy to be deformed. Comparatively, when the user touches the substrate 102 at a position where the reflective structures 830a are located, the reflective structures 830a are easy to be deformed. Therefore, the position where the reflective structures 830b are located may serve as a reference position of a touch position on the plane parallel to the first sensing electrode layer 810 when the touch and pressure sensing device 800 senses a user's touch operation. When the touch and pressure sensing device 800 simultaneously performs touch sensing and pressure sensing, an electric signal from the touch sensing and an electric signal from the pressure sensing can be easily determined according to the reference position, such that the touch and pressure sensing device 800 has a better sensing effect on the touch sensing and the pressure sensing.

In the present embodiment, a difference between the Young's modulus value of the material of the reflective structures 830a of the first touch and pressure sensing area and the Young's modulus value of the material of the reflective structures 830b of the second touch and pressure sensing area is greater than 0.1 million pascal (MPa). In some embodiment, the reflective structures 830a and the reflective structures 830b with proper Young's modulus values can be set according to the touch and pressure sensing design of the touch and pressure sensing device 800, which is not limited by the disclosure. To be specific, similar to the touch and pressure sensing device 100a of the embodiment of FIG. 1A, the touch and pressure sensing device 800 integrates the touch sensing function, the pressure sensing function and the optical transmission function in a single device, and the components of the touch and pressure sensing device 800 are simple, and the material cost and fabrication cost thereof are relatively low.

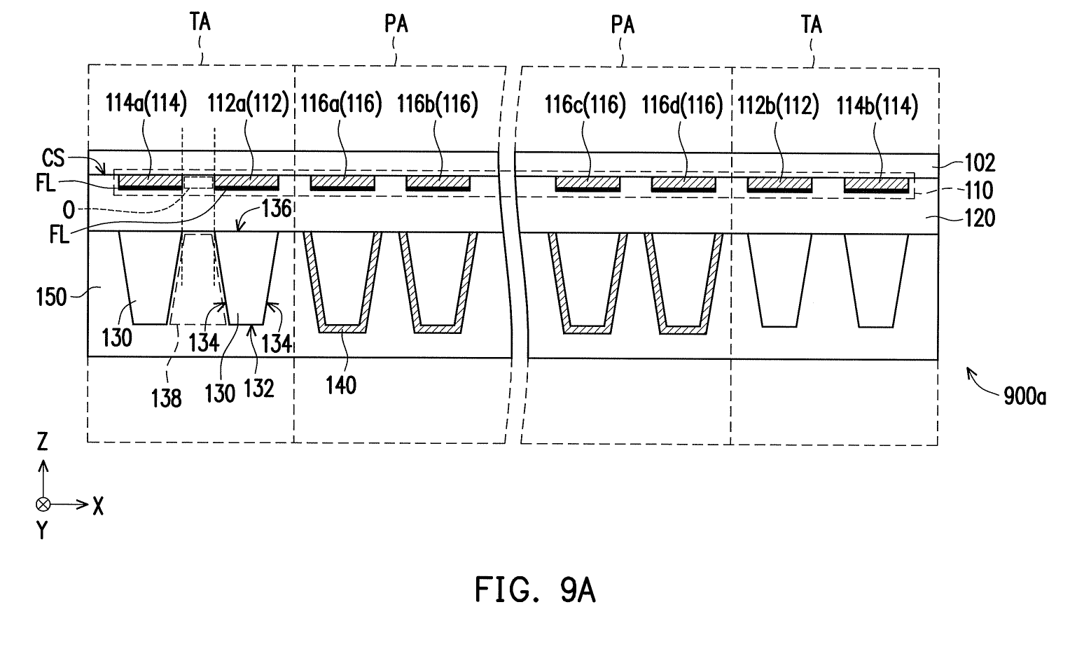

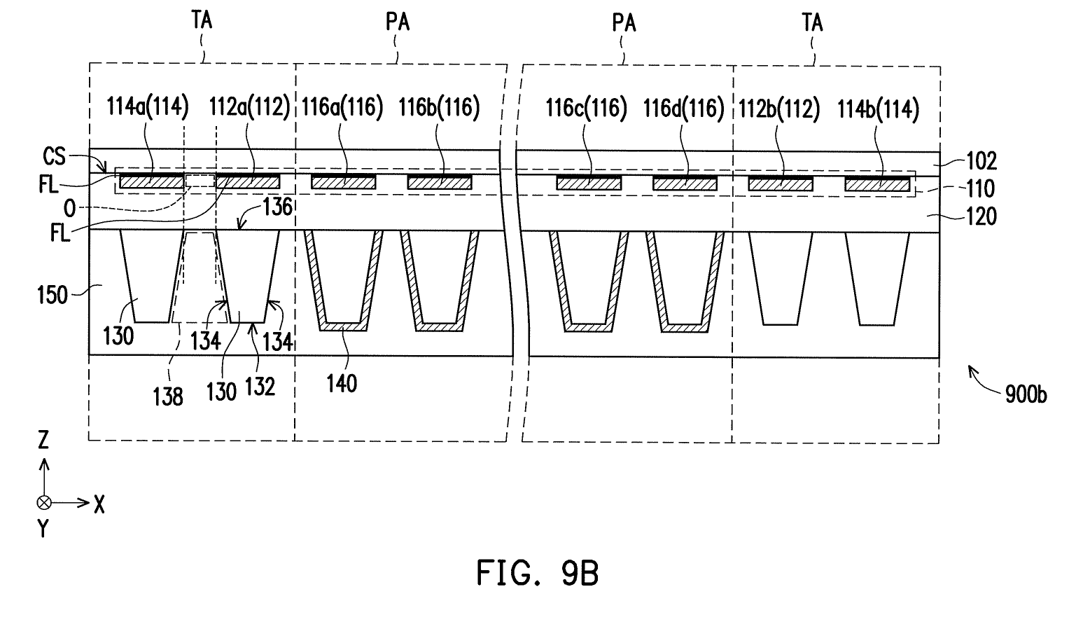

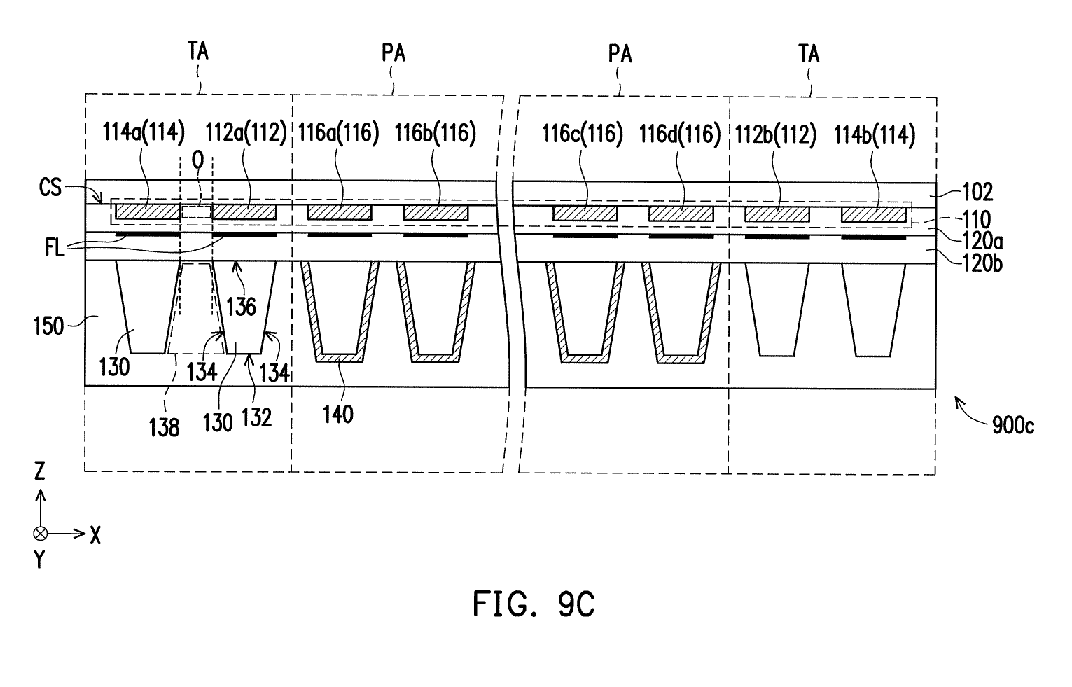

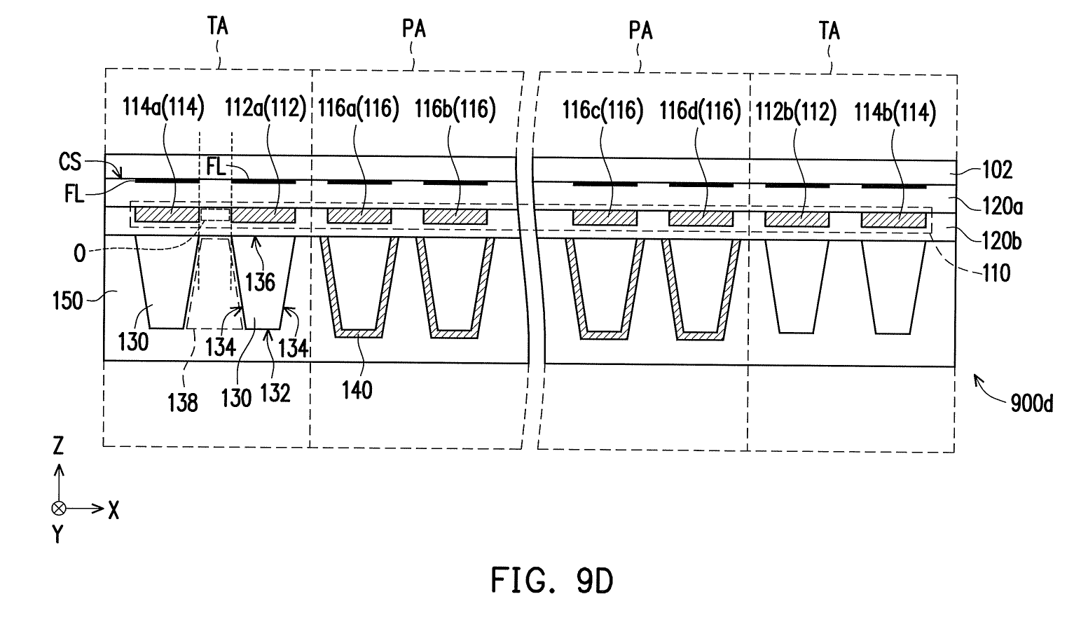

FIG. 9A is a cross-sectional view of a part of a touch and pressure sensing device according to still another embodiment of the disclosure, and FIG. 9B is a cross-sectional view of a part of a touch and pressure sensing device according to yet another embodiment of the disclosure. In these embodiments, the touch and pressure sensing device 900a of FIG. 9A and the touch and pressure sensing device 900b of FIG. 9B are all similar to the touch and pressure sensing device 100a of the embodiment of FIG. 1C. Description of the components of the touch and pressure sensing device 900a and the touch and pressure sensing device 900b may refer to related description of the touch and pressure sensing device 100a of the embodiment of FIG. 1C, and detail thereof is not repeated. Referring to FIG. 9A, a difference between the touch and pressure sensing device 900a and the touch and pressure sensing device 100a is that the touch and pressure sensing device 900a further includes a filter layer FL disposed on a surface of the first sensing electrode layer 110 at a side away from the substrate 102. To be specific, the filter layer FL is disposed on surfaces of the first electrode 112, the second electrode 114 and the third electrode 116 at a side away from the substrate 102. In the present embodiment, the material of the first sensing electrode layer 110 is, for example, a transparent conductive material, and the filter layer FL has a lower transmittance. For example, the transmittance of the filter layer FL is, for example, smaller than 30%. Moreover, an overlapped area of the filter layer FL and the first sensing electrode layer 110 along the direction of the third axis Z exceeds 70% of the area of the first sensing electrode layer 110.

Then, referring to FIG. 9B, a difference between the touch and pressure sensing device 900b and the touch and pressure sensing device 100a is that the touch and pressure sensing device 900b further includes a filter layer FL disposed on a surface of the first sensing electrode layer 110 at a side close to the substrate 102. To be specific, the filter layer FL is disposed on surfaces of the first electrode 112, the second electrode 114 and the third electrode 116 at a side close to the substrate 102. In the present embodiment, the filter layer FL is similar to the filter layer FL of the embodiment of FIG. 9A. To be specific, in the embodiments of FIG. 9A and FIG. 9B, similar to the touch and pressure sensing device 100a of FIG. 1C, the touch and pressure sensing device 900a and the touch and pressure sensing device 900b integrate the touch sensing function, the pressure sensing function and the optical transmission function in a single device, and the material cost and fabrication cost thereof are relatively low.

FIG. 9C is a cross-sectional view of a part of a touch and pressure sensing device according to still another embodiment of the disclosure, and FIG. 9D is a cross-sectional view of a part of a touch and pressure sensing device according to yet another embodiment of the disclosure. In these embodiments, the touch and pressure sensing device 900c of FIG. 9C and the touch and pressure sensing device 900d of FIG. 9D are all similar to the touch and pressure sensing device 900a of the embodiment of FIG. 9A. Description of the components of the touch and pressure sensing device 900c and the touch and pressure sensing device 900d may refer to related description of the touch and pressure sensing device 900a of the embodiment of FIG. 9A, and detail thereof is not repeated. Referring to FIG. 9C, a difference between the touch and pressure sensing device 900c and the touch and pressure sensing device 900a is that the touch and pressure sensing device 900c includes an insulating layer 120a and an insulating layer 120b. The first sensing electrode layer 110 is disposed between the substrate 102 and the insulating layer 120a, and the insulating layer 120b is disposed between the insulating layer 120a and the planarization layer 150. Moreover, in the present embodiment, the filter layer FL is similar to the filter layer FL of the embodiment of FIG. 9A. The filter layer FL of the present embodiment is disposed between the insulating layer 120a and the insulating layer 120b. The filter layer FL is correspondingly disposed on the position where the first sensing electrode layer 110 is located along the direction of the third axis Z. For example, a projection range of the filter layer FL on the carrying surface CS along the direction of the third axis Z falls within a projection range of the first sensing electrode layer 110 on the carrying surface CS along the direction of the third axis Z. Alternatively, the projection range of the filter layer FL on the carrying surface CS along the direction of the third axis Z is overlapped with the projection range of the first sensing electrode layer 110 on the carrying surface CS along the direction of the third axis Z, which is not limited by the disclosure.

Then, referring to FIG. 9D, a difference between the touch and pressure sensing device 900d and the touch and pressure sensing device 900a is that the touch and pressure sensing device 900d includes an insulating layer 120a and an insulating layer 120b. In the present embodiment, the filter layer FL is similar to the filter layer FL of the embodiment of FIG. 9A. The filter layer FL is disposed between the substrate 102 and the insulating layer 120a, and the insulating layer 120b is disposed between the insulating layer 120a and the planarization layer 150. Moreover, the first sensing electrode layer 110 of the present embodiment is disposed between the insulating layer 120a and the insulating layer 120b. To be specific, similar to the filter layer FL of the embodiment of FIG. 9C, the filter layer FL of the present embodiment is correspondingly disposed on the position where the first sensing electrode layer 110 is located along the direction of the third axis Z. In the embodiments of FIG. 9A to FIG. 9D, similar to the touch and pressure sensing device 100a of FIG. 1C, the touch and pressure sensing device 900a, the touch and pressure sensing device 900b, the touch and pressure sensing device 900c and the touch and pressure sensing device 900d integrate the touch sensing function, the pressure sensing function and the optical transmission function in a single device, and the material cost and fabrication cost thereof are relatively low.

To be specific, in the touch and pressure sensing devices in the embodiments of FIG. 9A to FIG. 9D, configuration of the filter layer FL and related description of the filter layer FL can be at least applied to the touch and pressure sensing device 100a, the touch and pressure sensing device 100b, the touch and pressure sensing device 200a, the touch and pressure sensing device 200b, the touch and pressure sensing device 300a, the touch and pressure sensing device 300b, the touch and pressure sensing device 400, the touch and pressure sensing device 500, the touch and pressure sensing device 600, the touch and pressure sensing device 700 and the touch and pressure sensing device 800 of the embodiments of FIG. 1A to FIG. 8, which is not limited by the disclosure.

In summary, the insulating layer of the touch and pressure sensing device of the embodiment of the disclosure covers the first sensing electrode layer, and the insulating layer is disposed between the first sensing electrode layer and the second sensing electrode layer. The second sensing electrode layer is partially overlapped with the first sensing electrode layer. Therefore, the touch and pressure sensing device integrates the touch sensing function, the pressure sensing function and the optical transmission function in a single device, and the material cost and fabrication cost thereof are relatively low.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A touch and pressure sensing device, comprising:
a first sensing electrode layer;
an insulating layer, covering the first sensing electrode layer;
a plurality of reflective structures, wherein the insulating layer is disposed between the first sensing electrode layer and the reflective structures, each of the reflective structures has a first surface on a side away from the first sensing electrode layer, and each of the reflective structures has at least one side surface connected to the first surface;
a second sensing electrode layer, formed on the first surface and the side surface, wherein the second sensing electrode layer is partially overlapped with the first sensing electrode layer; and
a planarization layer, covering the second sensing electrode layer.

2. The touch and pressure sensing device as claimed in claim 1, wherein the first sensing electrode layer comprises a first electrode, a second electrode and a third electrode, one of the first electrode and the second electrode is a driving electrode configured to sense positions on a plane substantially parallel to the first sensing electrode layer, the other one of the first electrode and the second electrode is a sensing electrode configured to sense positions on the plane substantially parallel to the first sensing electrode layer, and the second sensing electrode layer and the third electrode are overlapped, wherein the third electrode and the second sensing electrode layer are configured to sense a press position variation along a depth direction substantially perpendicular to the first sensing electrode layer.

3. The touch and pressure sensing device as claimed in claim 2, wherein the first electrode comprises a plurality of first electrode regions, the second electrode comprises a plurality of second electrode regions, and the third electrode comprises a plurality of third electrode regions, each of the first electrode regions is disposed adjacent to one of the second electrode regions to form a touch sensing area, wherein the first electrode regions and the second electrode regions are electrically insulated.

4. The touch and pressure sensing device as claimed in claim 3, wherein each of the third electrode regions is disposed between two adjacent touch sensing areas, the touch and pressure sensing device further comprises a connection layer, the insulating layer is disposed between the first sensing electrode layer and the connection layer, and the first electrode regions or the second electrode regions are connected and electrically conducted through the connection layer.

5. The touch and pressure sensing device as claimed in claim 3, wherein each of the touch sensing areas is disposed between two adjacent third electrode regions, the touch and pressure sensing device further comprises a connection layer, the insulating layer is disposed between the first sensing electrode layer and the connection layer, and the third electrode regions are connected and electrically conducted through the connection layer.

6. The touch and pressure sensing device as claimed in claim 1, wherein the first sensing electrode layer comprises a plurality of first sub-sensing electrodes, the second sensing electrode layer comprises a plurality of second sub-sensing electrodes, the first sub-sensing electrodes are separated from each other, the second sub-sensing electrodes are separated from each other, and the first sub-sensing electrodes and the second sub-sensing electrodes form a plurality of overlapped areas.

7. The touch and pressure sensing device as claimed in claim 6, wherein the overlapped areas comprise a first touch and pressure sensing area and a second touch and pressure sensing area, a Young's modulus value of a material of the reflective structures of the first touch and pressure sensing area is different to a Young's modulus value of a material of the reflective structures of the second touch and pressure sensing area, and a difference between the Young's modulus value of the material of the reflective structures of the first touch and pressure sensing area and the Young's modulus value of the material of the reflective structures of the second touch and pressure sensing area is greater than 0.1 million pascal (MPa).

8. The touch and pressure sensing device as claimed in claim 1, wherein a light guide space is formed between two adjacent reflective structures, and the planarization layer is filled in the light guide spaces.

9. The touch and pressure sensing device as claimed in claim 8, wherein the first sensing electrode layer has a plurality of openings, and the openings expose the light guide spaces.

10. The touch and pressure sensing device as claimed in claim 9, wherein the first sensing electrode layer comprises a plurality of transparent conductive electrodes, and each of the transparent conductive electrodes is disposed in one of the openings.

11. The touch and pressure sensing device as claimed in claim 1, wherein a refractive index of the planarization layer is greater than a refractive index of the reflective structures.

12. The touch and pressure sensing device as claimed in claim 1, wherein a refractive index of the planarization layer ranges from 1.3 to 2.0.

13. The touch and pressure sensing device as claimed in claim 1, wherein a refractive index of the reflective structures ranges from 1.0 to 1.7.

14. The touch and pressure sensing device as claimed in claim 1, wherein each of the reflective structures is a reflective wall, and the reflective walls are arranged in a grid layout.

15. The touch and pressure sensing device as claimed in claim 1, wherein each of the reflective structures has a second surface on a side adjacent to the first sensing electrode layer, and an area of the second surface is greater than an area of the first surface.

16. The touch and pressure sensing device as claimed in claim 1, wherein an overlapped area of the first sensing electrode layer and the second sensing electrode layer exceeds 70% of the first sensing electrode layer.

17. A touch and pressure sensing device, comprising:
a first sensing electrode layer, comprising a first electrode, a second electrode and a third electrode, wherein one of the first electrode and the second electrode is a driving electrode configured to sense positions on a plane substantially parallel to the first sensing electrode layer, and the other one of the first electrode and the second electrode is a sensing electrode configured to sense positions on the plane substantially parallel to the first sensing electrode layer;
an insulating layer, covering the first sensing electrode layer; and
a second sensing electrode layer, wherein the insulating layer is disposed between the first sensing electrode layer and the second sensing electrode layer, and the second sensing electrode layer is overlapped with the third electrode, wherein the third electrode and the second sensing electrode layer are configured to sense a press position variation along a depth direction substantially perpendicular to the first sensing electrode layer.

18. The touch and pressure sensing device as claimed in claim 17, wherein the first electrode comprises a plurality of first electrode regions, the second electrode comprises a plurality of second electrode regions, and the third electrode comprises a plurality of third electrode regions, each of the first electrode regions is disposed adjacent to one of the second electrode regions to form a touch sensing area, wherein the first electrode regions and the second electrode regions are electrically insulated.

19. The touch and pressure sensing device as claimed in claim 18, wherein each of the third electrode regions is disposed between two adjacent touch sensing areas, the touch and pressure sensing device further comprises a connection layer, the insulating layer is disposed between the first sensing electrode layer and the connection layer, and the first electrode regions or the second electrode regions are connected and electrically conducted through the connection layer.

20. The touch and pressure sensing device as claimed in claim 17, wherein a sum of an area of the first electrode and an area of the second electrode exceeds 20% of an area of the first sensing electrode layer.
